(19) United States
(12) Patent Application Publication
(10) Pub. No.: US 2023/0311898 A1
(43) Pub. Date: Oct. 5, 2023

(54) RECOMMENDING ACTIVITIES FOR OCCUPANTS DURING VEHICLE SERVICING

(71) Applicant: Rivian IP Holdings, LLC, Plymouth, MI (US)

(72) Inventors: Jason Quint, Ann Arbor, MI (US); Michael Moore, Chenoa, IL (US); Christopher Marshall Jacobs, Palo Alto, CA (US)

(21) Appl. No.: 17/708,612

(22) Filed: Mar. 30, 2022

(51) Int. Cl. B60W 40/08; G01C 21/36

(52) U.S. Cl. CPC B60W 40/08; G01C 21/3605; B60W 2555/20; B60W 2540/229; B60W 2540/22; B60W 2540/01

(57) ABSTRACT

Systems and methods for providing activity recommendations to occupants of a vehicle are provided, particularly for the intent of motivating the occupants to engage in certain physically and/or mentally beneficial activities. A method, according to one implementation, includes the step of detecting when a vehicle has been driven to a vehicle servicing facility. The method also includes the step of providing activity recommendations to one or more people present in the vehicle when the vehicle has been driven to the vehicle servicing facility.

### INTRODUCTION

The present disclosure generally relates to vehicles. More particularly, the present disclosure relates to a system configured to provide recommendations to occupants of a vehicle during servicing or charging of the vehicle to encourage the occupants to engage in nearby activities, particularly activities with physically and mentally healthful benefits.

Recharging an electrically-powered vehicle may take time, particularly when the battery system is largely depleted and/or the vehicle is being charged for a long trip. Typically, even more time may be required when the vehicle is brought in for maintenance. While their vehicles are being charged or otherwise serviced, if the vehicles' users have smartphones or other wireless devices, the users may choose to spend the time streaming video or otherwise accessing content from the Internet. However, if the user is at a location where their device is unable to access the Internet or receive a reasonable signal, or if their data plans are limited, then users may not be able to access or retrieve the content they desire.

The statements in this section merely provide background information related to the present disclosure and may not constitute prior art.

### BRIEF SUMMARY

Disclosed embodiments include systems and computer-implemented methods to provide media content from a media server associated with a vehicle servicing or charging system to a media presentation device associated with a vehicle using the vehicle servicing or charging system via a local network.

In an illustrative embodiment, a system includes a media presentation device associated with a vehicle including: a processor; and computer-readable media configured to store computer-executable instructions configured to cause the processor to: responsive to detecting that the media presentation device is communicatively couplable to a vehicle servicing system, communicatively couple the media presentation device to a media server associated with the vehicle servicing system via a local network; provide a user of the media presentation device with access to media content available via the media server; and retrieve the media selection via the media server and the local network e.g., for presentation via the media presentation device responsive to a user selection of a media selection from the media content.

In another illustrative embodiment, a media server associated with a vehicle servicing system includes a processor; and computer-readable media configured to store computer-executable instructions configured to cause the processor to: responsive to a request from a media presentation device communicatively couplable to a vehicle servicing system, communicatively couple the media server to the media presentation device via a local network; provide a user of the media presentation device with access to media content available via the media server; and retrieve the media selection and present the media selection via the local network e.g., for presentation via the media presentation device responsive to a user selection of a media selection from the media content.

In another illustrative embodiment, an illustrative computer-implemented method includes, responsive to detecting that a system is communicatively couplable to a vehicle servicing system, communicatively coupling the system to a media server associated with the vehicle servicing system via a local network; providing the system with media content available from the media server; and retrieving at least one media selection from the media server to the system via the local network.

According to still other embodiments, an activity recommendation process may be executed for encouraging occupants of a vehicle to engage in various activities that are available near a vehicle servicing facility, such as during the servicing of a vehicle. Thus, recommendations can be provided to give an incentive for the occupants to engage in activities having physical and mental benefits. The process may include the step of detecting when a vehicle has been driven to a vehicle servicing facility. The process may also include the step of providing activity recommendations to one or more people present in the vehicle when the vehicle has been driven to the vehicle servicing facility. For instance, one or more of the activity recommendations include an encouragement for the one or more people to engage in a real-life experience. In some embodiments, the process may be incorporated into a vehicle-based system or on-board system, such as one that includes an in-dash media interface for displaying information to the occupants and/or receiving input from the occupants.

According to some embodiments, the activity recommendation process may further include the step of providing a reward to the one or more people who engage in the real-life experience. The reward may be in the form of a digital token or badge. The process may include the step of storing one or more digital tokens or badges in a passport file of a suitable memory device. Each of the activities associated with the activity recommendations may be assigned a specific number of points that may be obtained upon completion of the real-life experience. The process may also include the step of keeping a running total of the number of points for use in a personal game involving only the one or more people of the single vehicle and/or in a family-competition game involving members of other vehicles. The step of providing the reward may include the step of receiving some type of verification that the one or more people have actually engaged in the real-life experience.

The activity recommendation process may utilize a media presentation device, where the activity recommendations may be presented to the one or more people via the media presentation device. In addition, the process may include displaying an initial interactive screen on the media presentation device the first time that the vehicle is driven to the vehicle servicing facility. For instance, this initial interactive screen may be configured to display instructions to the one or more people to explain the general concept of the activity recommendations. The initial interactive screen may also be configured to receive information about the one or more people who wish to participate in the game. The initial screen is configured to display rules of a game associated with the activity recommendations and how points are scored in the game. Also, the process may include receiving one or more digital images or pictures from a user's mobile device in communication with the media presentation device. Also, the media presentation device may be configured to receive personal comments or commentary about the activities, which can be kept private for the sole use of the family and/or can be shared with others. The photos and/or comments can be uploaded to a media server that is configured to maintain the game for multiple participants in multiple vehicles.

The one or more activity recommendations may be provided based on their proximity to the vehicle servicing facility. The one or more activity recommendations may also be based on an estimated time that the vehicle is to be serviced at the vehicle servicing facility. In some cases, the vehicle may be an electric vehicle, whereby the vehicle servicing facility may include a charging station for charging the battery of the electric vehicle. As such, the estimated time may be based on a charging time for charging the electric vehicle.

Furthermore, the one or more activity recommendations described with respect to the process may be based on the age, interest level, and ability level of each of the one or more people. The one or more activity recommendations may also be based on current weather conditions at the vehicle servicing facility, the time of day, and the season of the year. The activity recommendations may include one or more inside recommendations and one or more outside recommendations. For example, the one or more inside recommendations may be configured to encourage the one or more people to engage in one or more activities inside the vehicle and the one or more outside recommendations may be configured to encourage the one or more people to engage in one or more activities outside the vehicle.

Also, the activity recommendations may be grouped into one or more categories including at least a health and fitness category, an educational category, a spiritual or mental health category, and an entertainment category, just to name a few. For example, the health and fitness category may include an encouragement for the one or more people to engage in one or more real-life experiences including a) visiting a nearby park, b) walking along a nearby hiking trail, c) observing a nearby scenic view, d) playing a game of disc golf, e) searching for geo-caching sites, f) observing nature, g) going on a scavenger hunt, h) renting a bike or electric scooter from a nearby rental facility, and/or other physically healthful activities. The educational category may include an encouragement for the one or more people to engage in one or more real-life experiences including a) viewing a video of a nearby park or historic site, b) viewing a video about vehicle maintenance, c) listening to an audio book, and/or other mental healthful activities. The spiritual or mental health category may include an encouragement for the one or more people to engage in one or more real-life experiences including a) listening to audio of Bible passages, b) listening to suggestions or instructions with respect to prayer or meditation, c) listening to philosophical quotes, and/or other spiritually healthful activities. The entertainment category may include an encouragement for the one or more people to engage in one or more real-life experiences including a) visiting a nearby ice cream parlor, theater, shopping mall, coffee shop, or farmer's stand, b) visiting a local attraction, and/or other entertaining activities that may include some level of physical or mental benefits.

Further features, advantages, and areas of applicability will become apparent from the description provided herein. It will be appreciated that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIGS. 1A, 1B, and 2 are block diagrams of illustrative environments including a media server and a local network to provide media content to a media presentation device;

FIG. 3 is a perspective view of a cabin of a vehicle that includes one or more embodiments of a media presentation device;

FIGS. 4-9 are block diagrams of an illustrative media presentation device, a media server, and a remote storage system;

FIGS. 10-20 are block diagrams of illustrative media presentation device and illustrative screen displays for accessing, selecting, and presenting a media selection from media content available from the media server and/or remote storage;

FIGS. 21-23 are block diagrams in partial schematic form of illustrative vehicles that may include the media presentation system of FIGS. 1-20;

FIG. 24 is a block diagram of an illustrative computing device for performing functions of the media presentation system, the media server, or the remote storage of FIGS. 4-9;

FIG. 25 is a block diagram of an operating and communications environment of the media presentation device, media server, and remote storage;

FIG. 26 is a flow chart of an illustrative method for providing media content from a media server associated with a vehicle servicing system to a media presentation device associated with a vehicle;

FIG. 27 is a block diagram of a computing system to enable communication of possible activities for occupants to engage in;

FIG. 28 is a display screen provided on a display device for showing folders or a passport of various categories of activities;

FIG. 29 is a “relax” screen associated with a spiritual or mental category of activities related to the passport shown in FIG. 28;

FIG. 30 is an “explore” screen associated with a health and fitness category of activities or an adventure category of activities related to the passport shown in FIG. 28;

FIG. 31 is a “learn” screen associated with an educational category of activities related to the passport shown in FIG. 28;

FIGS. 32A and 32B are screenshots of description information provided with respect to an example group of activities that may be coordinated in partnership with local park organizations, forestry/park services, nature organizations, camping/hiking organizations, family-friendly activity/game organizations, or other organizations; and

FIG. 33 is a flow chart of an illustrative method for providing recommendations to encourage occupants of a vehicle to engage in physically and mentally healthful activities.

### DETAILED DESCRIPTION

The following description explains, by way of illustration only and not of limitation, various embodiments.

By way of a non-limiting introduction and overview, in various embodiments, a media presentation device associated with a vehicle is configured to access a media server associated with a vehicle servicing system, such as a charging station or another vehicle maintenance facility. To enable the user to make worthwhile use of the time involved in charging or maintaining the vehicle, the media presentation device is able to access the media server via a wired or wireless local network. Thus, without consuming an allotment of smartphone data and, potentially at higher speed afforded by the local network, the user is able to stream or download media content. The user may be able to filter available media content according to one or more criteria to identify one or more media selections of interest and/or that are time-suitable for a time available to enjoy the media content and/or location-suitable in that the one or more media selections pertain to a current location or to a location the user may travel by or to. If a desired media selection is not stored locally on the media server, the media server may retrieve the media selection from remote storage and then pass the media selection to the media presentation device. In various embodiments, a user may choose media selections according to the duration of the program or the user may choose a media selection associated with a location, destination, or route of the vehicle.

Now that a general overview has been given, details of various embodiments will be explained by way of non-limiting examples given by way of illustration only and not of limitation.

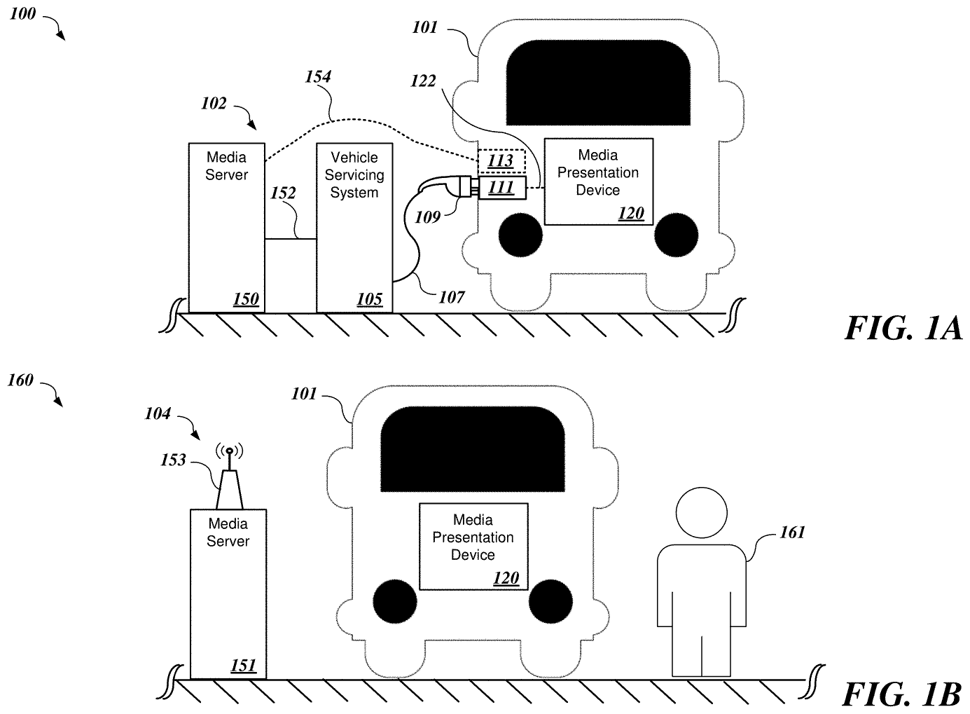

Referring to FIG. 1A, a vehicle 101 is being charged or otherwise serviced at a vehicle servicing facility 100. The vehicle includes a local network 102. In various embodiments, the local network 102 provides for communication between a media presentation device 120 associated with the vehicle 101 and a media server 150. In various embodiments, the media presentation device 120 is communicatively coupled by a wired system to the media server 150 to request and receive media selections (not shown in FIG. 1A). In various embodiments, the vehicle servicing system 105, such as a charging device or a vehicle diagnostic system, is coupled to the vehicle 101 via a cable 107 and a coupling 109 that is coupled to a vehicle coupling 111. When the vehicle servicing system 105 is in the form of a charging device, the cable 107 may include a charging cable, and the coupling 109 may include a charging coupling, such as a Combined Charging System (CCS). The vehicle servicing system 105 also may include a diagnostic device and the cable 107 may include a diagnostic cable 154 couplable with a diagnostic interface 113.

The vehicle servicing system 105, in turn, is communicatively coupled with the media server 150 via a wired connection 152 and, in turn, with the media presentation device 120 via the cable 107. In various embodiments, the cable 107 may include dedicated signal lines for media communications that convey signals to and from the media server 150 via the wired connection 152. In various embodiments, the media server 150 may communicate over the wired connection cable 107 using a piggybacked, modulated signal via conductors used to provide electric power, comparable to Powerline networking. The media signals may be modulated at a frequency that does not interfere with and is not interfered with by the supply of electrical power over those same conductors. Thus, the media presentation device 120 of the vehicle 101 may receive media selections from the media server 150 while the user is waiting for the vehicle 101 to be charged or otherwise serviced.

Referring additionally to FIG. 1B, in various embodiments, the local network 104 may include a wireless network. In various configurations, the wireless local network at a vehicle maintenance facility 160 enables the media presentation device 120 associated with the vehicle 101 to be communicatively coupled with a media server 151 using wireless communications while the vehicle 101 is being charged or undergoing preventative, routine, or corrective maintenance. In such a case, while service personnel 161 work on the vehicle 101 or the vehicle 101 is being recharged, the media presentation device 120 may be used to access the media server 151 via a wireless access point or router 153 without a wired connection between the vehicle 101 and the media server 151. In various embodiments, the wireless access point 153 may support IEEE 802-type Wi-Fi communications that provides reliable, high-speed communications over a range up to hundreds of feet.

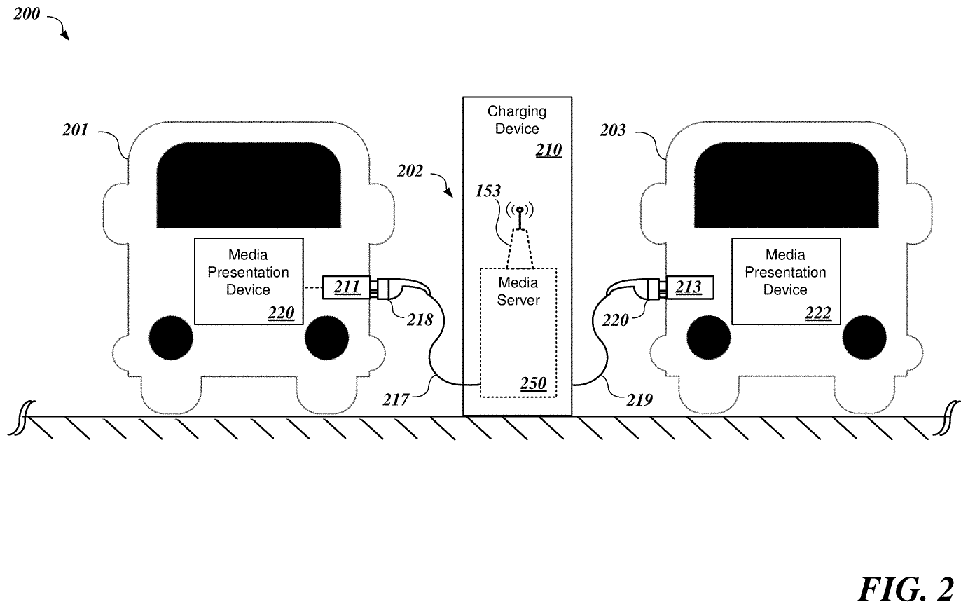

Referring additionally to FIG. 2, in various embodiments, a local network 202 may employ both wired and wireless communications. Multiple vehicles 201 and 203 are parked at a vehicle servicing facility 200, for example, to use a charging device 210 to charge battery systems (not shown in FIG. 2) of the vehicles 201 and 203. A media server 250 may be remote from but logically coupled to the charging device 210 and/or the media server 250 may be physically integrated with the charging device 210 or another vehicle servicing system. One media server 250 may service multiple media presentation devices 220 and 222 associated with one or more vehicles 201 and 203 just as other file servers may serve multiple nodes. The media server 250 may communicate with different media presentation devices 220 and 222 using different communications media.

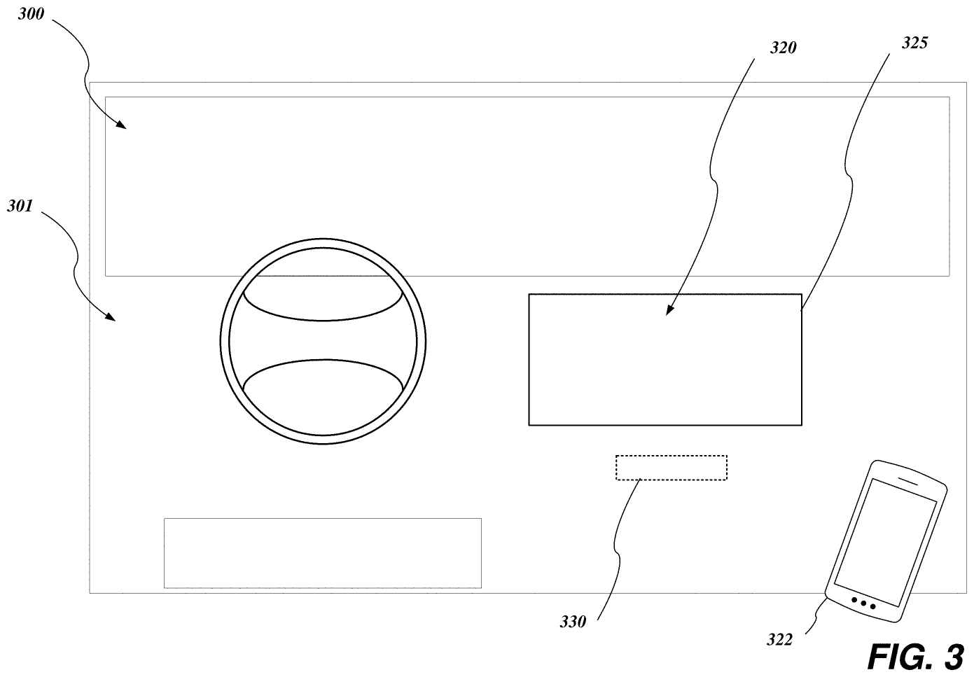

In various embodiments, the media presentation device 220 associated with the vehicle 201 may communicate with the media server 250 using wired communications via a charging cable 217 and a charging coupler 218 coupling the charging device 210 to a vehicle coupling 211, as previously described with reference to FIG. 1A. As shown in FIG. 2, the charging cable 217 may be physically coupled to the media server 250 to enable communications via dedicated signal lines or via a signal piggybacked on conductors used to provide electric power to the vehicle 201, as also previously described with reference to FIG. 1A. In addition, the media presentation device 222 associated with the vehicle 203 may communicate with the media server 250 using wireless communications supported by a wireless access point or router 153 associated with the media server 250. Although the vehicle 203 is coupled to the charging device 210 via a charging cable 219 and a charging coupler 220 coupled to the vehicle coupling 213 of the vehicle 203, the selection and delivery of media selections between the media server 250 and the media presentation device 222 may be independent of the wired connection provided by the charging cable 219. Wireless communication may be used when the media presentation devices 220 and 222 include on-board presentation devices integrated into the vehicles 201 and 203 or when the media presentation devices 220 and 222 include separate devices associated with the vehicles 201 and 203, as further described with reference to FIG. 3.

Referring additionally to FIG. 3, the media presentation devices 120, 220, and 222 of FIGS. 1A-B and 2 may include an on-board presentation device 320 integrated into a dashboard or console 301 within a cabin 300 of a vehicle. The on-board presentation device may also provide navigation control features as well as control of climate controls and other vehicle systems, as well as media playback controls via an interactive display 325. The interactive display 325 may include an interactive, touchscreen display or may be controllable via separate input devices (not shown in FIG. 3).

The media presentation devices 120, 220, and 222 of FIGS. 1A-B and 2 also may include a portable presentation device 322, such as a smartphone, tablet computer, or other portable device. The portable presentation device 322 may wirelessly communicate with the media server 150 or 250 (FIGS. 1A-B and 2) directly or may communicate wirelessly or using wired communications with an integrated communications node 330 incorporated into the vehicle. The communications node 330 may communicate with the media server 150 or 250 with wired and/or wireless communications and relay selections and media selections between the portable presentation device 322 and the media server 150 or 250. It will be appreciated that, if the media server 150 or 250 is used to provide a proprietary service to a particular type of vehicle or to authorized users, the portable presentation device 322 may be logically associated with the vehicle or otherwise registered with the media server 150 or 250 to restrict access to the media server 150 or 250. It will also be appreciated that use of a portable presentation device 322 may enable a user to access a media selection away from the vehicle, for example, if the running time of a downloaded media selection exceeds a duration of charging or maintenance and the user wishes to complete the program at a later time.

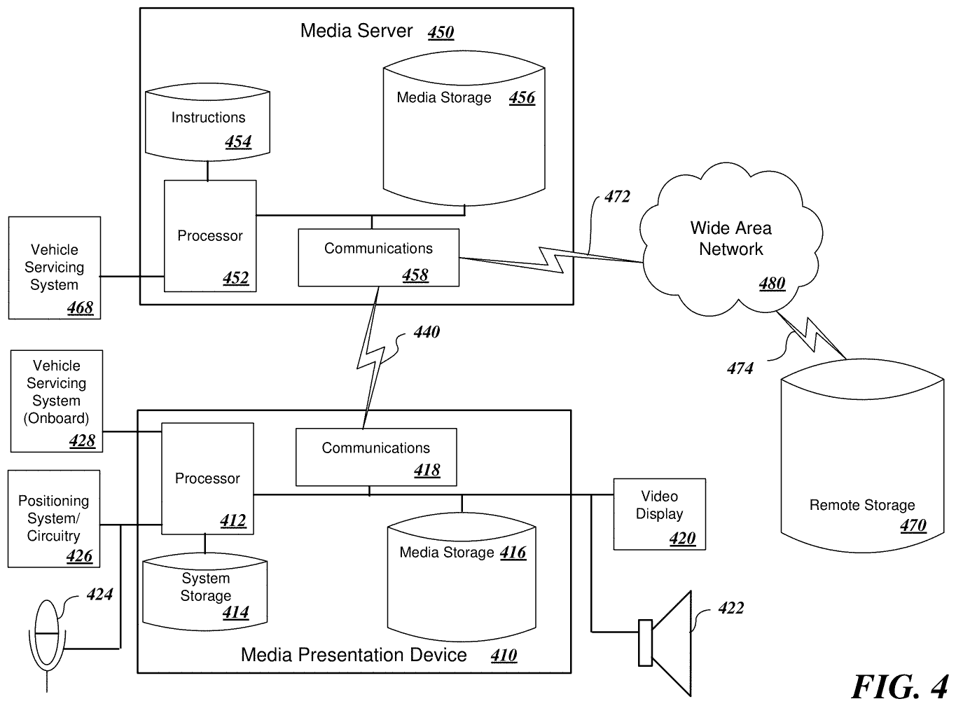

Referring additionally to FIG. 4, a media presentation device 410 interacts with a media server 450 to access media selections via the media server 450. As previously described, the media presentation device 410 may be integrated within a vehicle (not shown in FIG. 4) or may include a portable device. As also previously described, the media presentation device 410 may communicate with the media server 450 using wired and/or wireless communications. In various embodiments, the media presentation device 410 is a computing device that includes a processor (which may include system memory and other supporting logic) 412 that is operated according to computer-executable instructions stored in system storage 414. In various embodiments, the media presentation device 410 may include separate media storage 416 to buffer, cache, download, or otherwise store media selections receivable from the media server 450. In various embodiments, the media storage 416 may be integrated or combined with the system storage 414. The media presentation device 410 also includes a communications system 418 to enable the media presentation device 410 to communicate via wired communications with the media server 450 and/or with a portable presentation device 322 (FIG. 3). The media presentation device 410 also may include or be coupled with a video display 420, such as an interactive display 325 (FIG. 3), to present video information and/or to receive user input. The media presentation device 410 also may include or be coupled with an audio output system 422, such as a speaker system, headphones, or another audio output device. The media presentation device 410 also may include or be coupled with an audio input system 424, such as a microphone or another audio input device to receive verbal commands, for example, to select or control presentation of media selections.

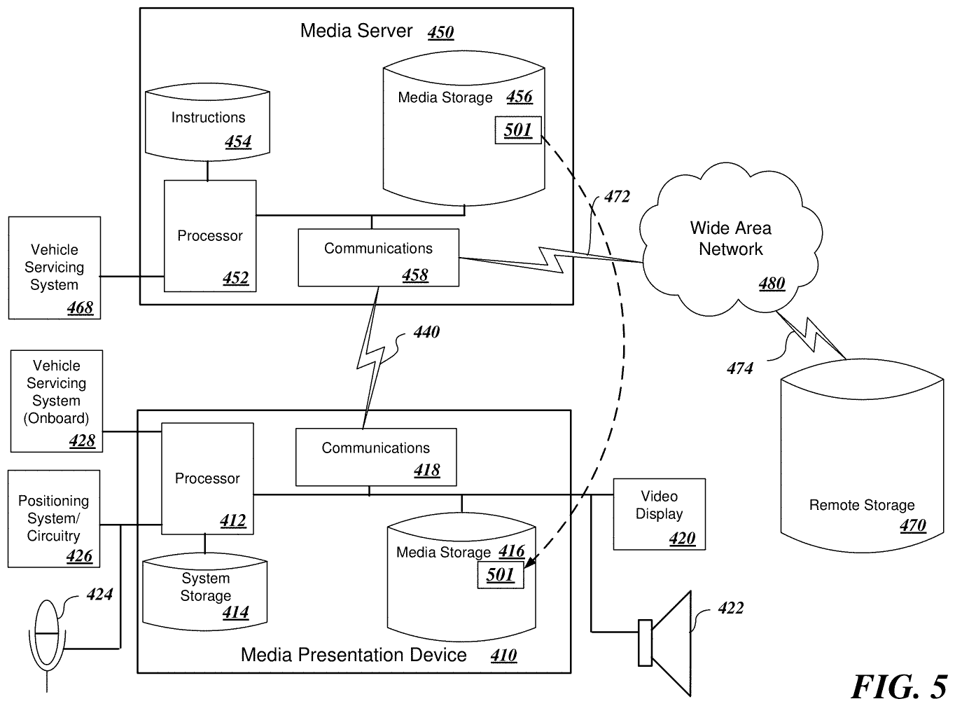

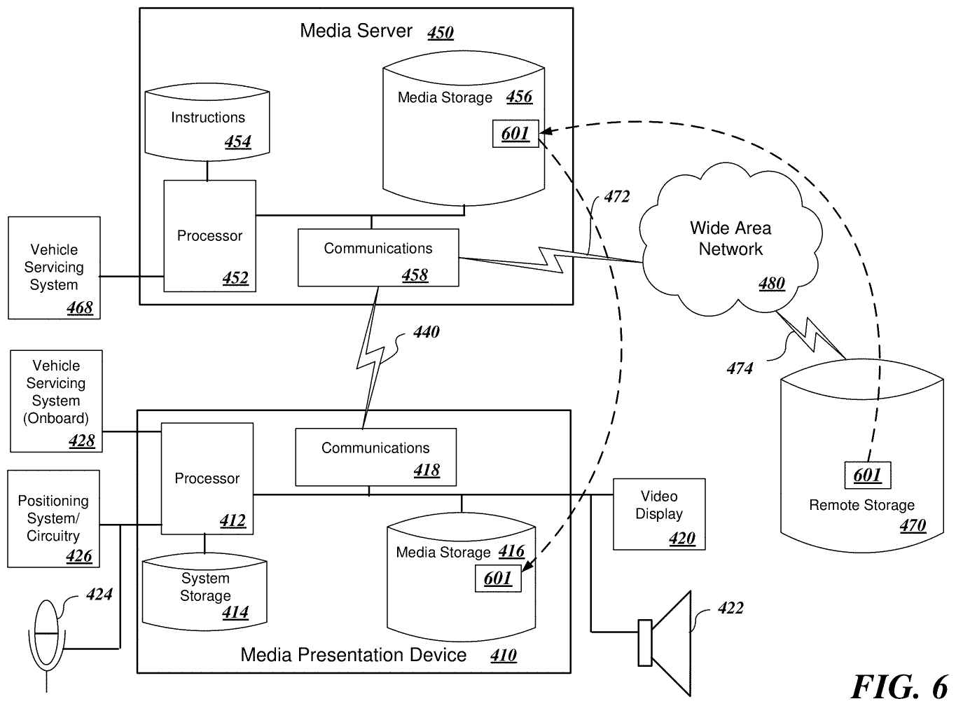

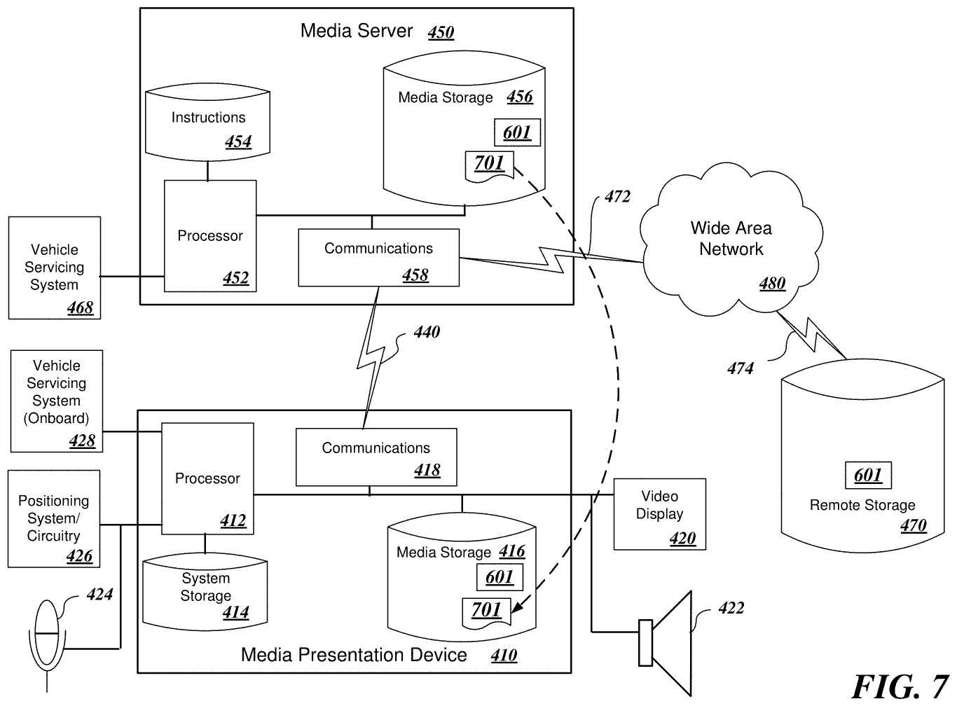

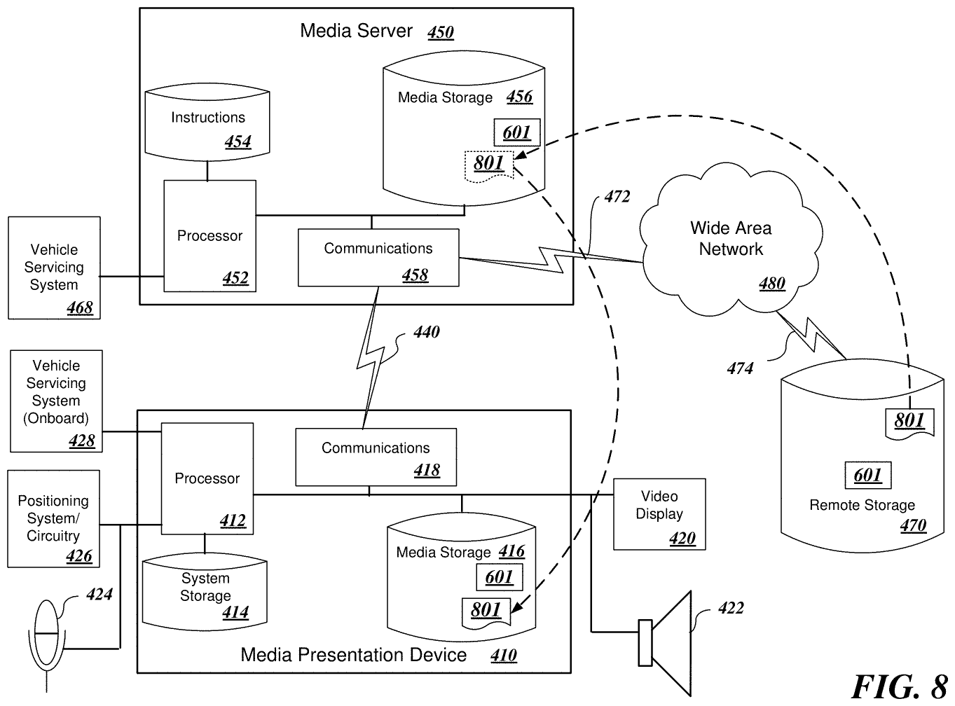

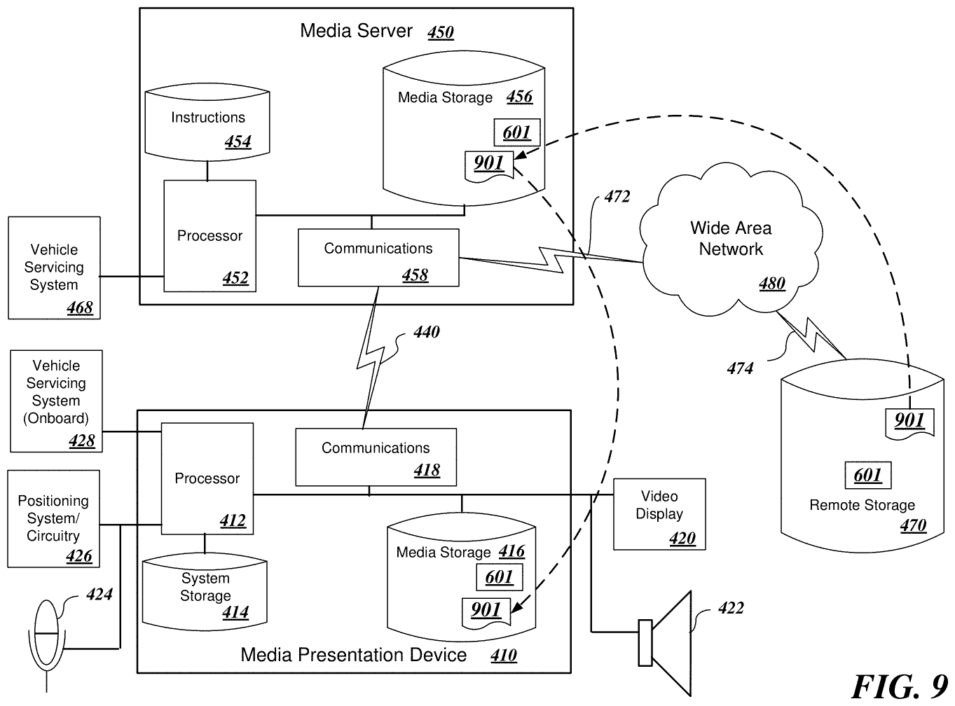

Additionally, FIGS. 5 to 9 illustrate example operations of the media presentation device 410 interacting with the media server 450 to access media selections. In FIG. 5, media 501 is provided from the media storage 456 to the media storage 416, such as between the communications 418, 458. In FIG. 6, media 601 is received by the media storage 456 from the remote storage 470, such as via the wide area network 480, and the media 601 is provided from the media storage 456 to the media storage 416, such as between the communications 418, 458. In FIG. 7, extending from FIG. 6, additional media 701 is provided from the media storage 456 to the media storage 416, such as between the communications 418, 458. In FIG. 8, extending from FIG. 6, media 801 is received by the media storage 456 from the remote storage 470, such as via the wide area network 480, and the media 801 is provided from the media storage 456 to the media storage 416. In FIG. 9, extending from FIG. 6, media 901 is received by the media storage 456 from the remote storage 470, such as via the wide area network 480, and the media 901 is provided from the media storage 456 to the media storage 416.

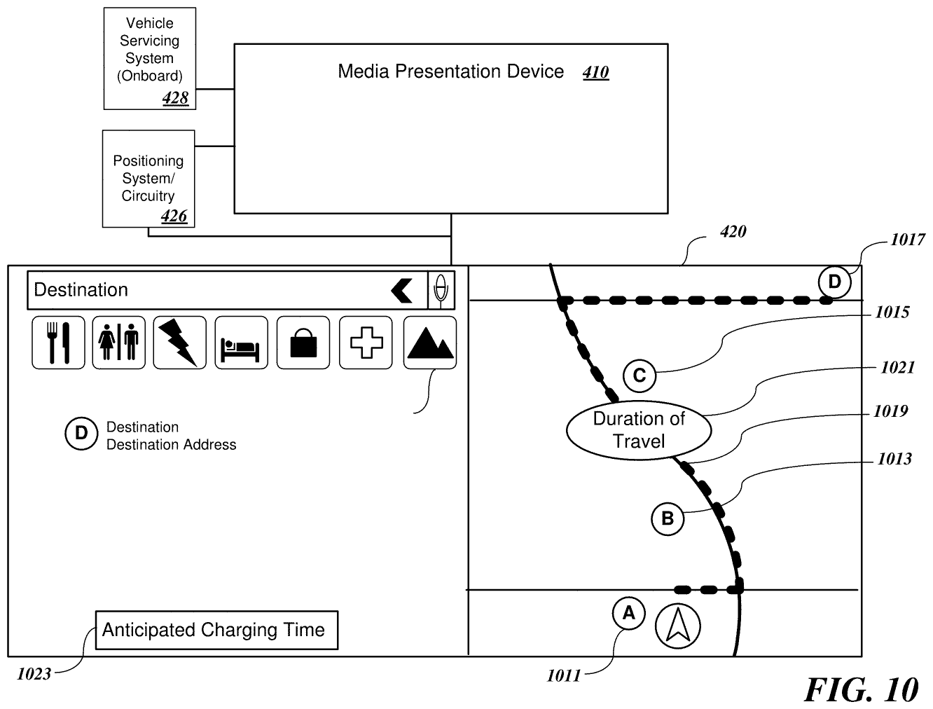

In various embodiments, the media presentation device 410 also is communicatively couplable with the positioning system or circuitry 426 of the vehicle and the positioning system or circuitry 426 also may use the video display 420 that is used by the media presentation device 410. In various embodiments, the positioning system or circuitry 426 may be configured to determine a current position A 1011, as shown in FIG. 10, of the vehicle. The positioning system or circuitry 426 also may be configured to track a specified destination D 1017 and identify points of interest B 1013 and C 1015 along a route 1019 from the current position A 1011 to the destination D 1017. As described below, the locations A 1011, B 1013, C 1015, and D 1017 or other locations along the route 1019 may be provided to the media presentation device 410 and may be used to help select one or more media selections that may be of interest to the user. In various embodiments, the media presentation device 410 also may communicate with the positioning system or circuitry 426 to access information about an anticipated duration of travel 1021 and/or the vehicle servicing system 428 to access information about an expected duration of servicing 1023, such as an anticipated charging time. These times may be used to help identify or filter available media content that is time-suitable according to at least one criterion, such as filtering or identifying media content that has a running time that fits within one of the durations 1021 and 1023, as further described below.

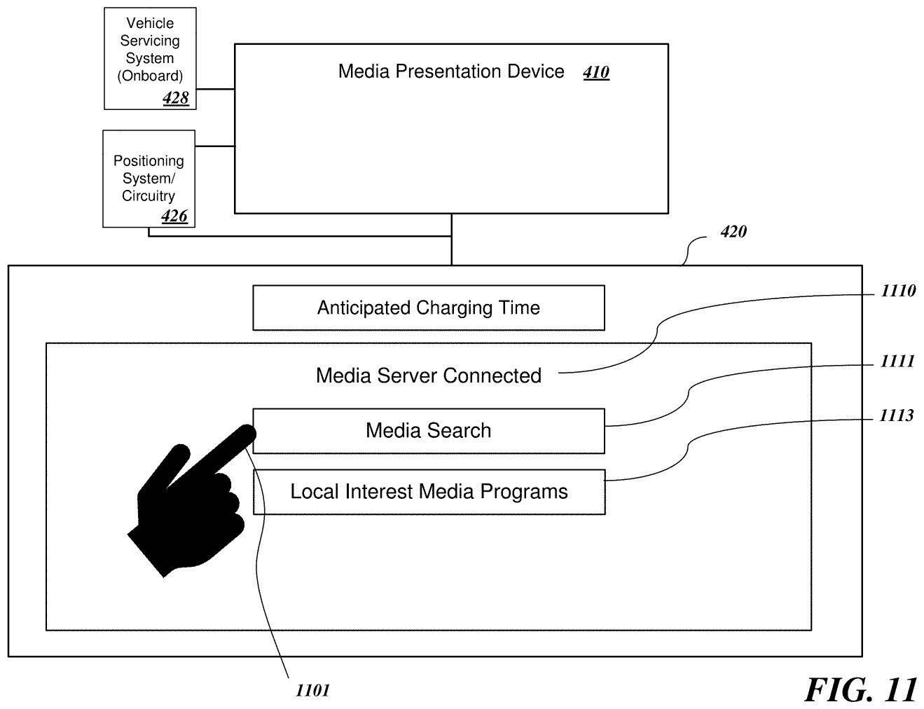

Referring additionally to FIG. 11, the video display 420 is used by the media presentation device 410 to enable the user to access and/or choose one or more media selections. The media presentation device 410 may detect a connection to a media server (not shown in FIG. 11) via wired or wireless connections and present an indication 1110 that the media presentation device 410 is connected to a media server. In various embodiments, a user may then initiate a media search, such as by using a digit 1101 to select a media search input 1111. Responsive to selecting the media search input 1111, a user may use the video display 420, the audio input system 424 (FIG. 4), or other inputs to search for media selections by title, keywords, or other qualifiers.

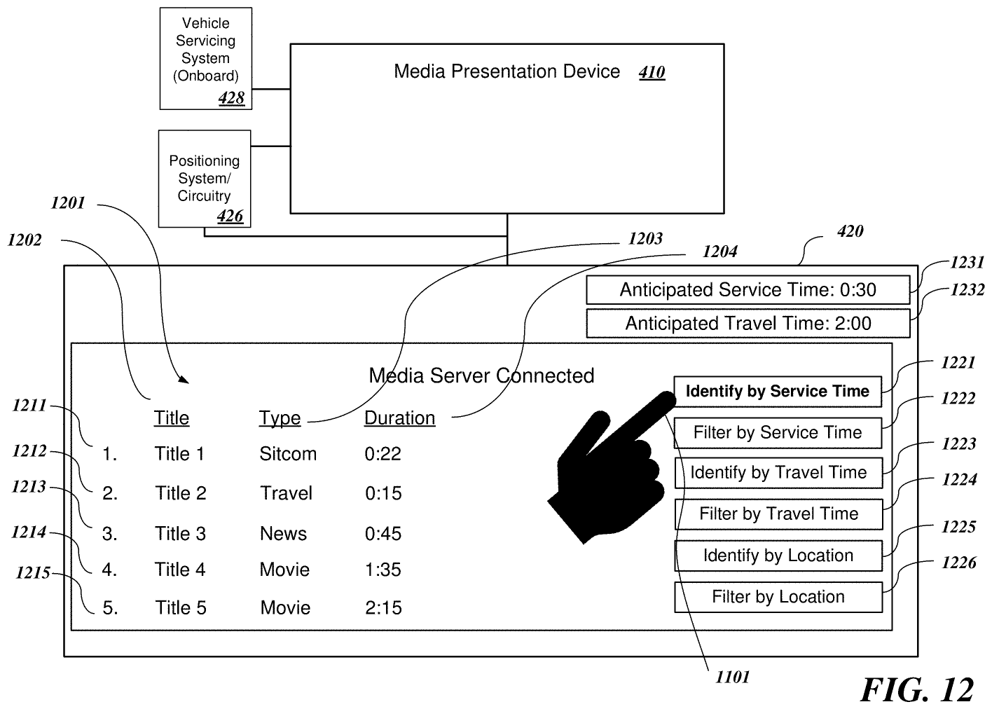

Referring additionally to FIG. 12, a list of media selections 1201 included in available media content responsive to the search request is presented. In various embodiments, entries for the media selections 1211-1215 included in the list of media selections 1201 may include a media selections title 1202, a media type 1203 (e.g., such as news, situation comedy, drama, movie, travel, etc.), and a duration 1204. In various embodiments, the media presentation device 410 may enable a user to select from among identification or filtering options 1221-1226 to assist in making a selection from the list of media selections 1201 included in the available media content according to one or more specified criteria, as further described below. It will be appreciated that the identification and filtering options 1221-1226 may be presented in a separate menu selectable from the list of media selections 1201, via a series of nested menus that invoke options (e.g., an identification by time-suitability may be presented from which service time or travel time may be selectable options), or by another interaction process. In various embodiments, the media presentation device may present an anticipated service time 1231 which, in the present example, is assumed to be a 30-minute charging time, and an anticipated travel time which, in the present example, is assumed to be two hours. These time periods are used for illustration only; the service and travel durations may be shorter or longer and are not limited to any particular period of time. In a first example, a user employs the digit 1101 to select the identify by service time option 1221.

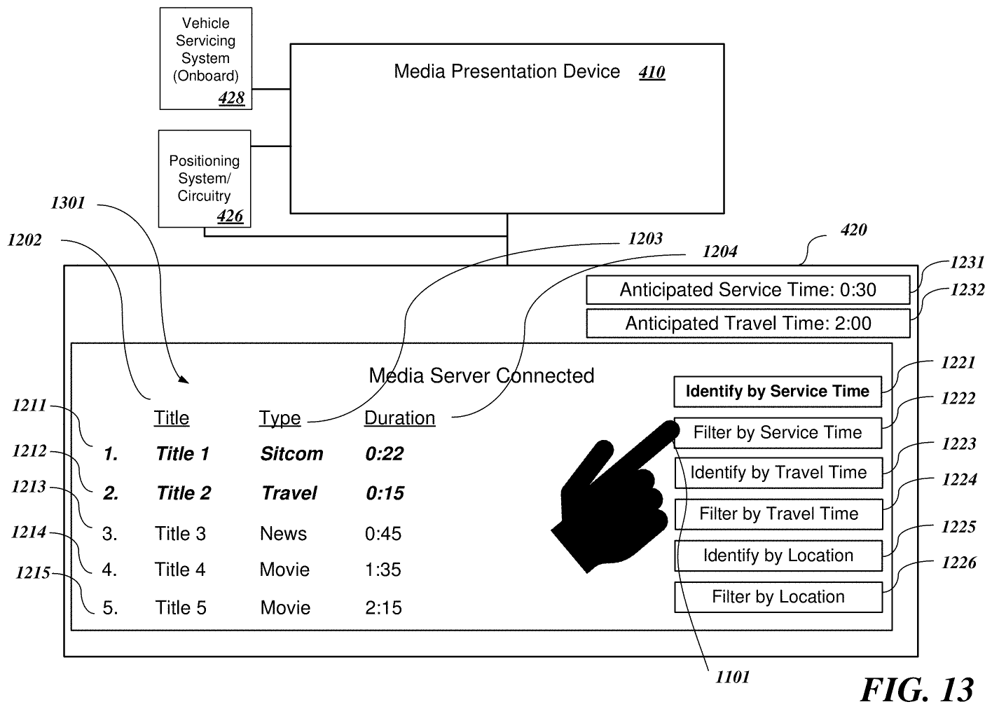

In various embodiments, for example, time-suitability may be a criterion for filtering or selecting from among media selections included in the available media content. Referring additionally to FIG. 13, responsive to the user selection of the identify by service time option 1221, a revised list of media selections 1301 visually identifies the media selections 1211 and 1212 that meet the time-suitability criterion in that the media selections 1211 and 1212 have a duration that is within the anticipated service time 1231. (In the example of FIG. 13, the media selections 1211 and 1212 that have a duration that is within the anticipated service time 1231 are highlighted in bold to identify the media selections 1211 and 1212 as meeting the selected criterion.) Accordingly, if the user is primarily interested in media that may be completed during servicing, the media presentation device 410 identifies such selections. It will be appreciated that the identification also may be performed by moving media selections that have a duration that fits within the anticipated service time 1231 and may be highlighted by moving them to the top of the video display 420, by presenting them in a different color, by diminishing the intensity of other media selections having a longer duration, or in any other way that differentiates among the display of the media selections. In various embodiments, the user may reverse the selection of the identify by service time option 1221 by touching the option again or by using another means of input. In addition, the user may make a different selection to replace the initial selection of the identify by service time option 1221 with another selection, for example, by using the digit 1101 to select a filter by service time option 1222.

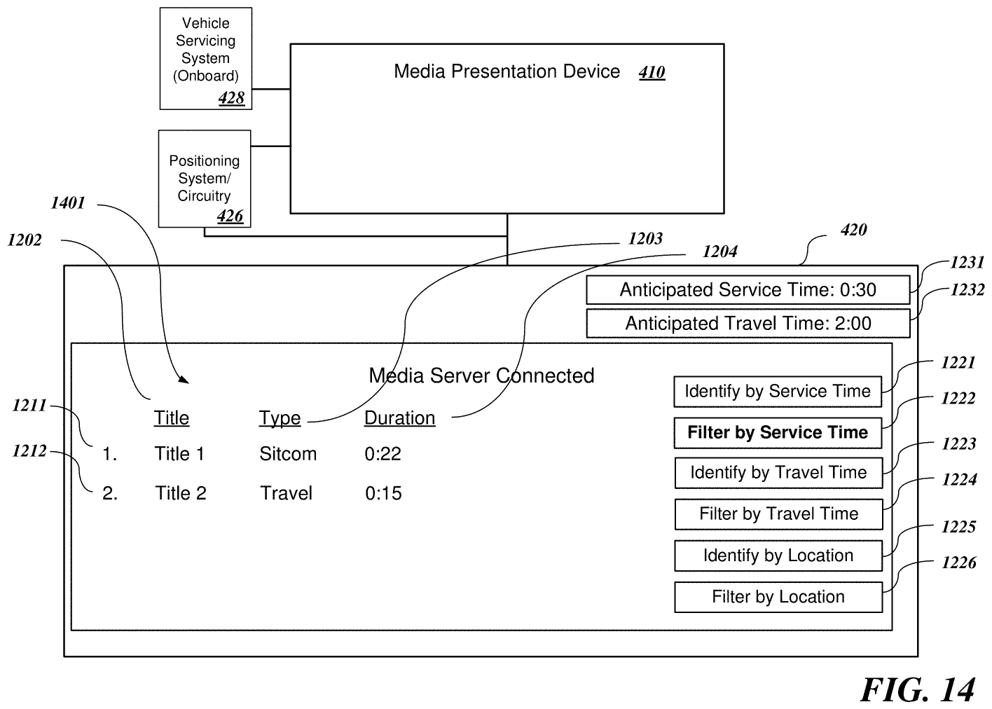

Referring additionally to FIG. 14, in various embodiments selecting the filter by service time option 122 causes a further revised list of media selections 1401 that includes only media selections 1211 and 1212 because they are the only programs that are time-suitable because they each have a duration that fits within the anticipated service time 1231.

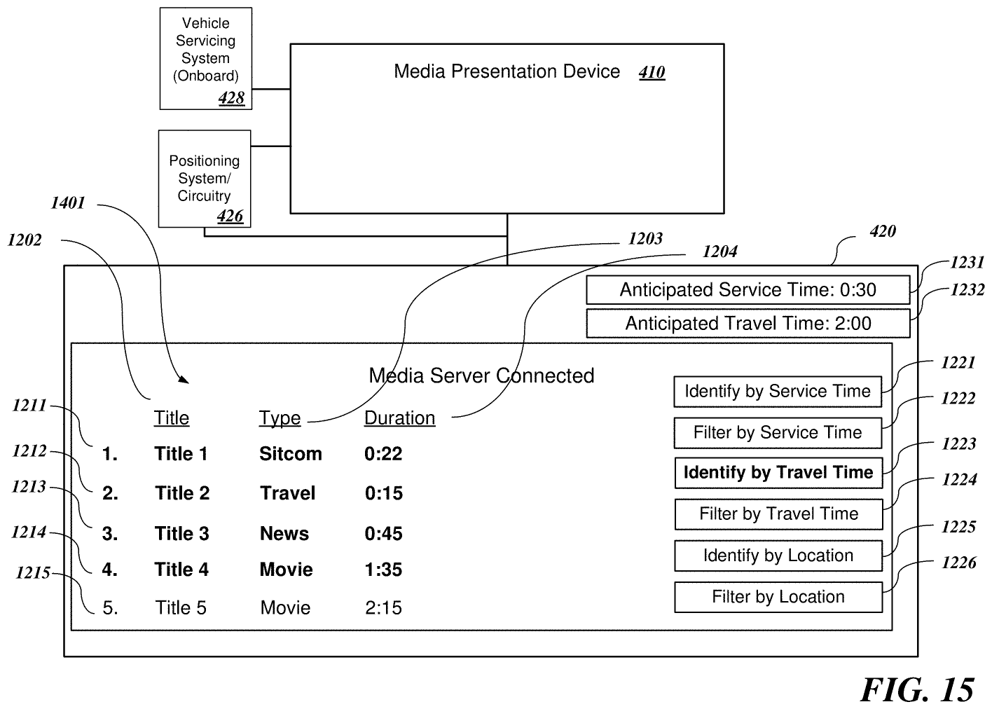

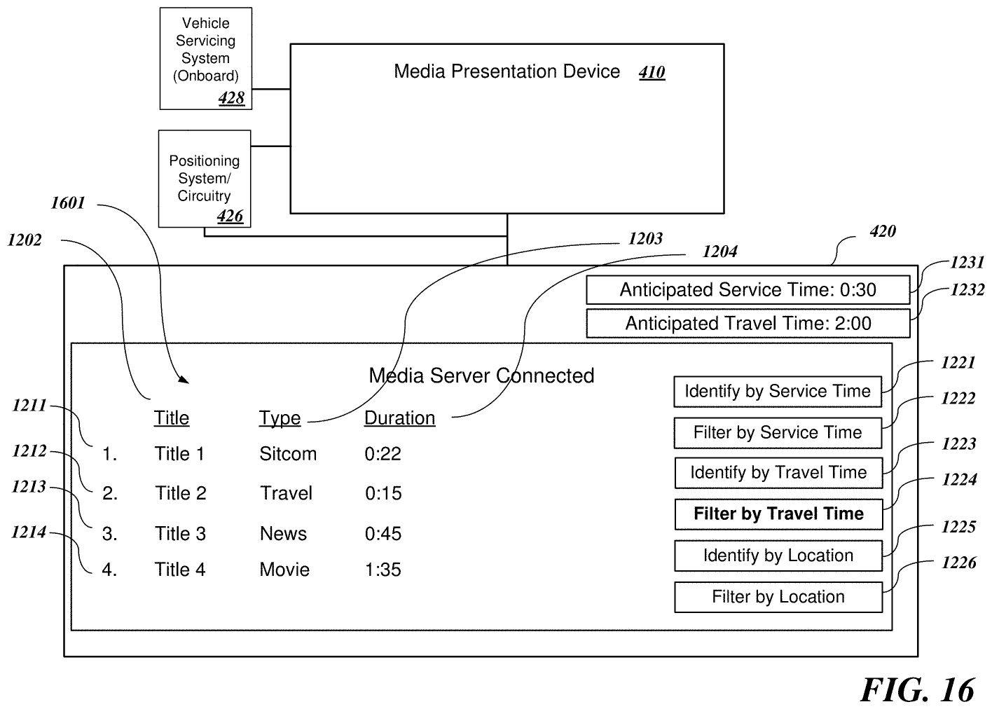

Referring additionally to FIG. 15, in various embodiments responsive to a user selection of the identify by travel time option 1223, a revised list of media selections 1501 highlights the time-suitable media selections 1211-1214 because each has a duration that will fit within the anticipated travel time 1232 (and, thus, may be presented to a driver of an autonomous vehicle and/or passengers). Referring additionally to FIG. 16, in various embodiments responsive to a user selection of the filter by travel time option 1224, a revised list of media selections 1601 includes only the media selections 1211-1214 because each has a duration that will fit within the anticipated travel time 1232.

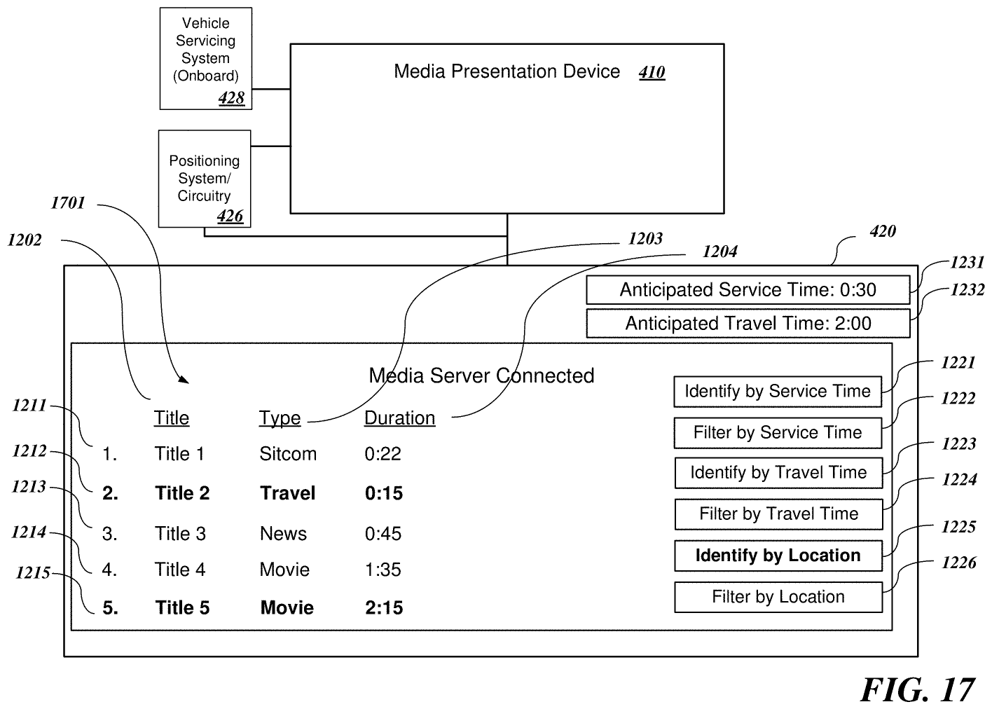

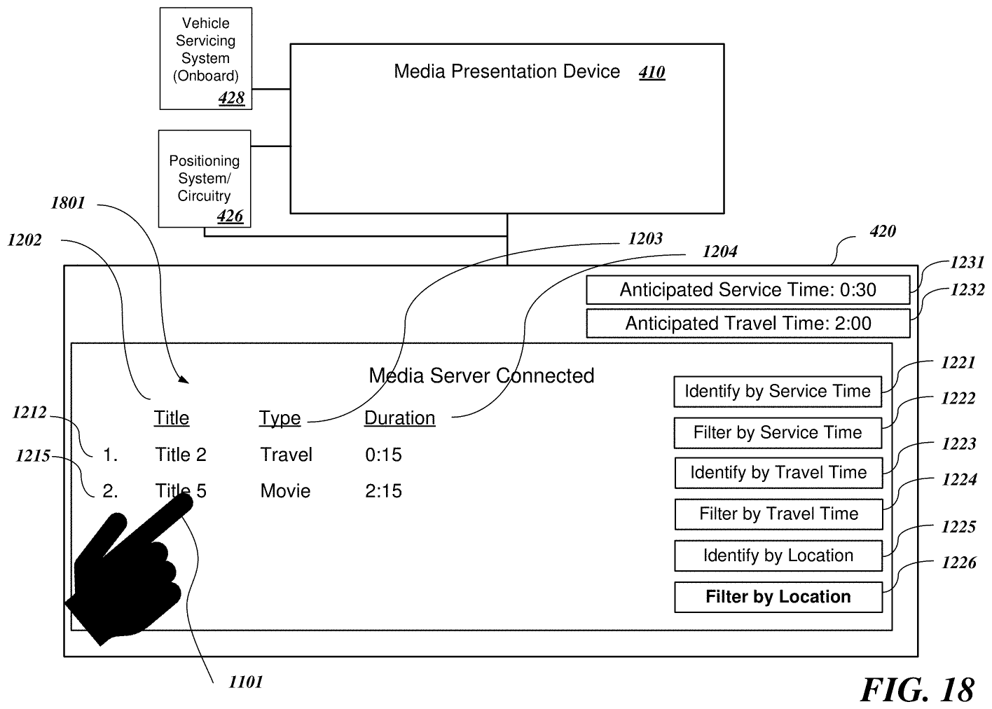

Referring additionally to FIG. 17, in various embodiments responsive to a user selection of the identify by location option 1225, a revised list of location-suitable media selections 1701 highlights the media selections 1212 and 1215 because, although not presented on the video display 420, the media selections 1212 and 1215 may be tagged as being about or set in an area that is near the locations A 1011, B 1013, C 1015, and D 1017 or other locations along the route 1019 (FIG. 10). For example, the media selection 1212 may include a feature about or relating to one of these locations. In various embodiments, the media selection 1212 may include a guided tour, such as described in U.S. patent application Ser. No. 17/387,209 entitled “TOUR GUIDE MODE USER INTERFACE AND EXPERIENCE,” filed on Jul. 28, 2021, and incorporated by reference herein. The media selection 1215 may have been tagged as having been set in or filmed in one of the locations A 1011, B 1013, C 1015, and D 1017 or other locations along the route 1019. Referring additionally to FIG. 18, in various embodiments responsive to a user selection of the filter by location option 1226, a revised list of media selections 1801 shows only the media selections 1212 and 1215 associated with one of the locations. Referring back to FIG. 11, in various embodiments, a user may be able to skip to selections such as those represented in FIGS. 17 and 18 by selecting the local interest media selections option 1113 to access location-suitable media selections.

In various embodiments, by selecting a media selection from one of the lists of media selections 1201, 1301, 1401, 1501, 1601, 1701, and 1801, a user may obtain additional information about the chosen selection, to present the program, or to download the program for later access. As shown in FIG. 18, for example, the user may use the digit 1101 to select the media selection 1215.

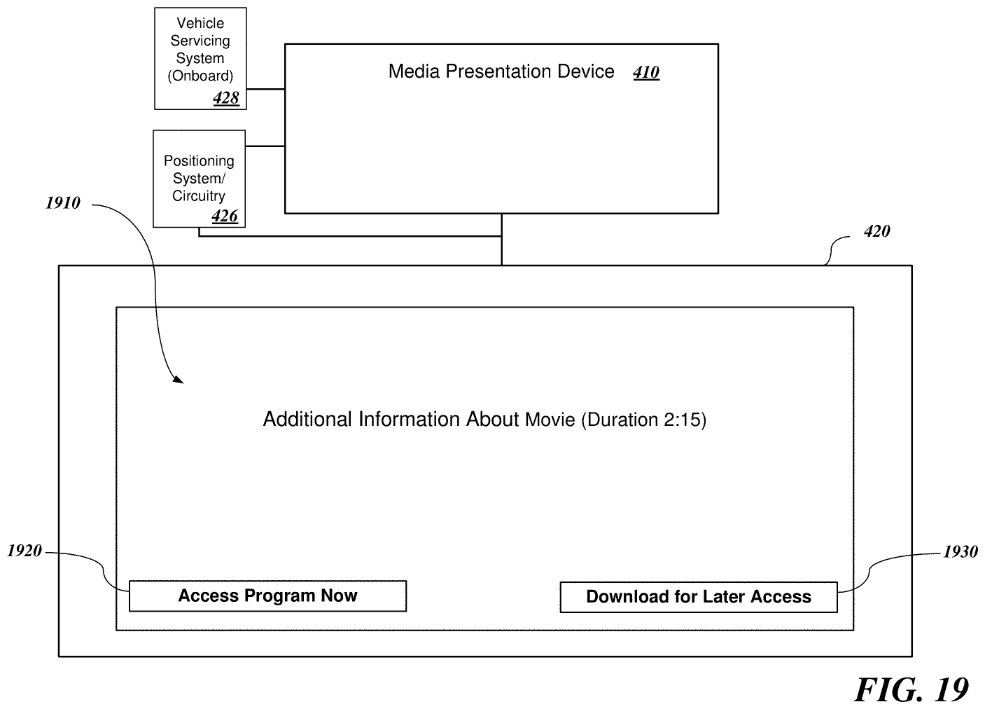

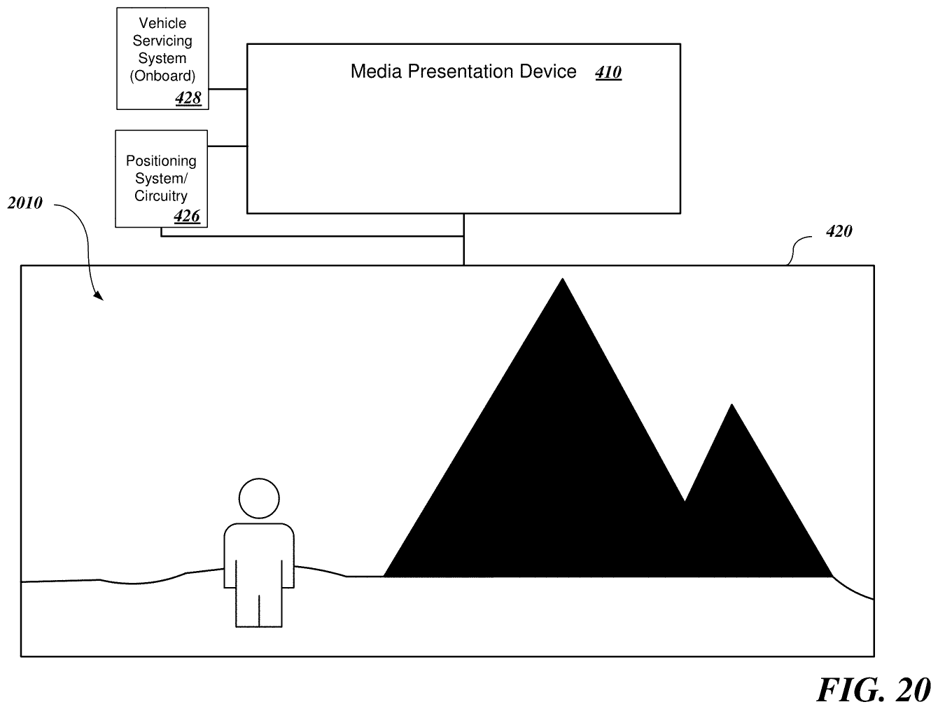

Referring additionally to FIG. 19, in various embodiments responsive to the choice of the media selection 1215, the media presentation device 410 may provide additional information 1910 about the media selection 1215 as well as options to access 1920 or download 1930 the media selection. Referring additionally to FIG. 20, responsive to the user choosing to access the media selection now or at a later time, the media presentation device presents content 2010 of the selected media selection via the video display 420 of the media presentation device 410 (as well as via the audio output system 422, as described with reference to FIG. 4).

As previously described with reference to FIG. 3, the media presentation device 410 may include an on-board system 320 integrated in the vehicle and/or a portable system 322 from which users can access the selected media selection or selections. In any case, as previously described, the media selections may be listed, selected, presented, and/or downloaded via the local network 102 (FIG. 1A), 104 (FIG. 1B), or 202 (FIG. 2) so that the user can access the media selection without having or using personal wide area network access via a smartphone, portable hotspot, or similar device.

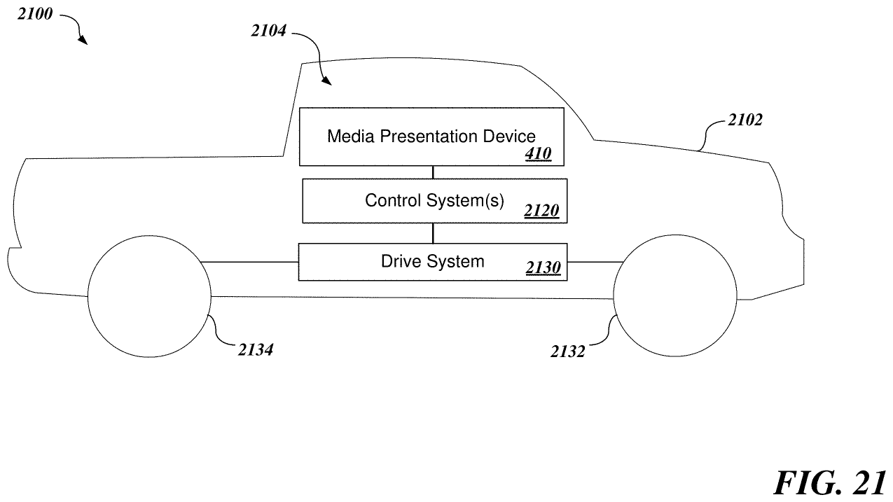

Referring additionally to FIG. 21, in various embodiments the media presentation device 410 may be integrated into or carried aboard any suitable vehicle 2100 as desired. A vehicle may include a car, truck, sport utility vehicle, van, recreational vehicle, marine vessel (such as a boat or a ship), aircraft (such as fixed-wing aircraft, rotary wing aircraft, and lighter-than-air craft), train, motorcycle, or a human-powered vehicle such as a bicycle, tricycle, unicycle, scooter, skateboard, or the like. In various embodiments, the vehicle 2100 includes a body 2102 and a cabin 2104 where the media presentation device 410 may be installed or transported and from which the media presentation device 410 may be accessed. The media presentation device 410 may be integrated with one or more control systems 2120, such as the positioning system or circuitry 426 and the vehicle servicing system 428 (FIG. 4) to obtain information about vehicle position, anticipated travel duration, and anticipated servicing duration, as previously described. The vehicle 2100 may include one or more drive systems 2130 that motivate wheels 2132 and/or 2134 to move the vehicle 2100.

In various embodiments, the control systems 2120 may include a self-driving system to enable the vehicle to drive autonomously without operator control. The control systems 2120 may also provide operator assistance features, such as automatic braking, lane-keeping assistance, and similar features.

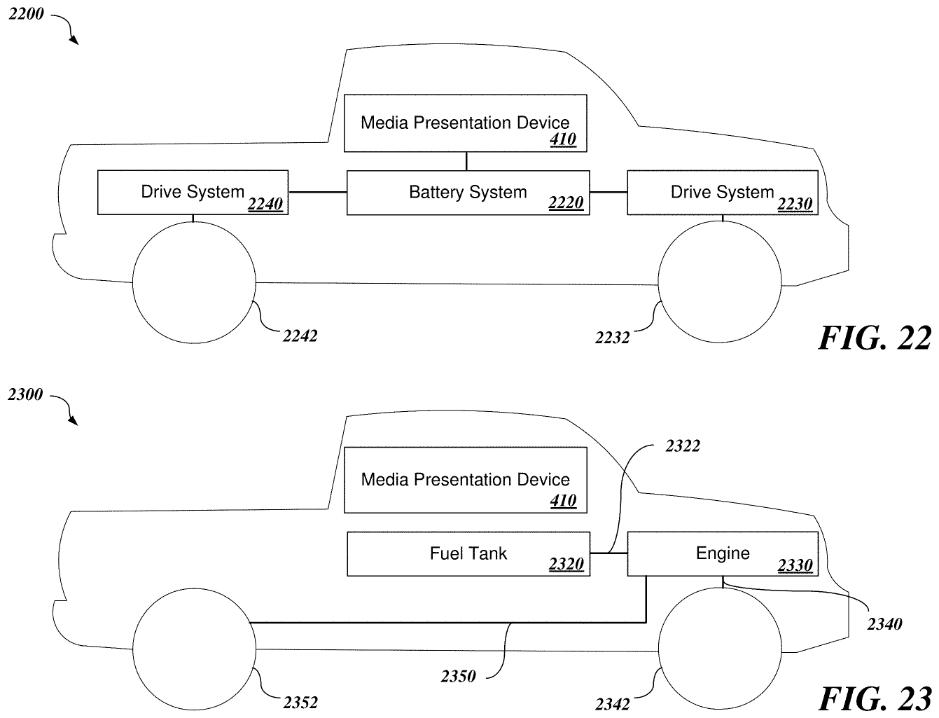

Referring additionally to FIG. 22, in various embodiments the vehicle 2100 may include an electrically-powered vehicle 2200 that incorporates or is able to transport the media presentation device 410. The media presentation device 410 may be coupled with a battery system 2220 of the vehicle 2200 as a source of electric power for the media presentation device 410 as well as to vehicle systems as described with reference to FIG. 21. The battery system 2220 may provide electric power to one or more drive systems 2230 and 2240 to motivate wheels 2232 and 2242. Referring additionally to FIG. 23, the vehicle 2100 may include an internal-combustion engine-powered vehicle 2300 that incorporates or is able to transport the media presentation device 410. The vehicle 2300 may include a fuel tank 2320 to provide fuel to an engine 2230 that, via linkages 2340 and 250, provides mechanical power to motivate the wheels 2342 and 2352, respectively. Although not expressly shown in FIGS. 22 and 23, the vehicles 2200 and 2300 may include control systems, such as a positioning system and circuitry and a vehicle servicing system, as previously described with reference to FIG. 4, that may provide information usable in selecting or filtering media content as previously described as well as other control systems as described with reference to FIG. 21.

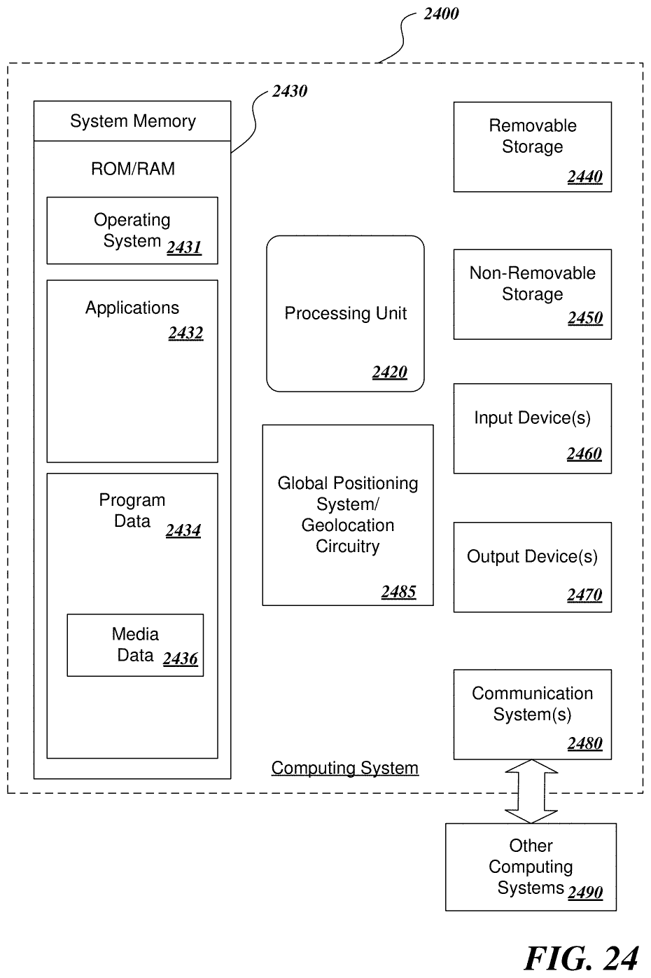

Referring additionally to FIG. 24 and given by way of example only and not of limitation, an illustrative computing device 2400 may be used aboard a vehicle to perform the functions of the media presentation device 120, the media server 150 (FIG. 1), and/or other systems as herein described. In various embodiments, the computing device 2400 typically includes at least one processing unit 2420 and a system memory 2430. Depending on the configuration and type of computing device, the system memory 2430 may include volatile memory, such as random-access memory (“RAM”), non-volatile memory, such as read-only memory (“ROM”), flash memory, and the like, or a combination of volatile memory and non-volatile memory. The system memory 2430 typically maintains an operating system 2432, one or more applications 2432, and program data 2434 to provide instructions to the processing unit 2420, such as the processors 412 and 452 previously described with reference to FIG. 4. The operating system 2432 may include any number of operating systems executable on desktop or portable devices including, but not limited to, Linux, Microsoft Windows®, Apple iOS®, or Android®, or a proprietary operating system. The applications 2432 may be configured to provide for the selection, retrieval, and access of media selections from among available media content, as previously described with reference to FIGS. 1-20. The program data 2434 may include the media storage 416 or 456 of the media presentation device 410 or media server 450 or the remote storage 470 as described with reference to FIG. 4.

The computing device 2400 may also have additional features or functionality. For example, the computing device 2400 may also include additional data storage devices (removable and/or non-removable) such as, for example, magnetic disks, optical disks, tape, or flash memory. Such additional storage devices are illustrated in FIG. 24 by removable storage 2440 and non-removable storage 2450. Computer storage media may include volatile and non-volatile, removable and non-removable media implemented in any method or technology for storage of information, such as computer-readable instructions, data structures, program modules or other data. The system memory 2430, the removable storage 2440, and the non-removable storage 2450 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic disk storage or other magnetic storage devices, or any other medium which can be used to store the desired information and which can be accessed by the computing device 2400. Any such computer storage media may be part of the computing device 2400.

The computing device 2400 may also have input device(s) 2460 such as a keyboard, stylus, voice input device, touchscreen input device, etc. Output device(s) 2470 such as a display, speakers, short-range transceivers such as a Bluetooth transceiver, etc., may also be included. The computing device 2400 also may include one or more communication systems 2480, such as the communications system 418 and 458 (FIG. 4) that allow the computing device 2400 to communicate with other computing systems 2490. As previously mentioned, the communication system 2480 may include systems for wired or wireless communications. Available forms of communication media typically carry computer-readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

In further reference to FIG. 24, the computing device 2400 may include the positioning system or circuitry 426 (FIG. 4) which may include global positioning system (“GPS”)/geolocation circuitry 2485 that can automatically discern its position based on relative distances to multiple GPS satellites or other signal sources, such as cellphone towers. As described further below, GPS/geolocation circuitry 2485 may be used to determine a position of the system. In various embodiments, the GPS/geolocation circuitry 2485 may be used to determine a position for generation and analysis of navigation information as well as for identifying media selections that may be relevant to a location.

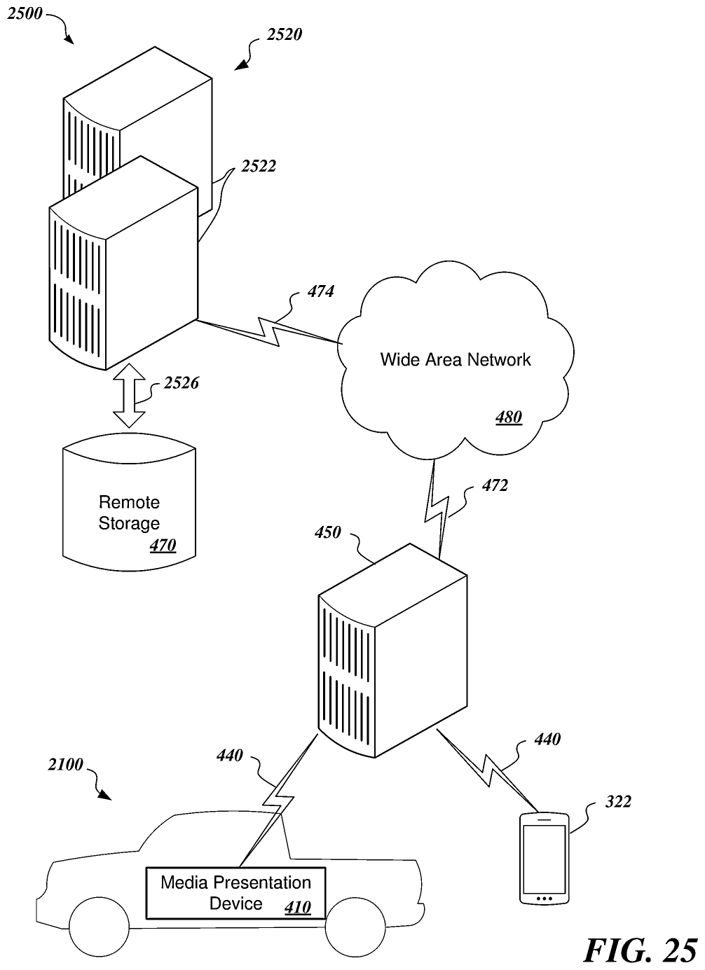

In addition to one or more onboard computing systems, various embodiments may communicate with remote computing systems to perform the functions herein described. Referring to FIG. 25, an operating environment 2500 may include one or more sets or remote computing systems 2520, each of which may include multiple computing devices 2522. The remote computing systems 2520 each may include a server or server farm and may communicate with the wide area network 480 over wired and/or wireless communications links 472 and 474, as described with reference to FIG. 4. The remote computing systems 2520 may be coupled by high-speed buses 2526 to interact with the remote storage 470 that stores media selections, as previously described with reference to FIG. 4. The remote computing systems 2520 may communicate with media servers 450, which also may include one or more computing devices 2400 as described with reference to FIG. 24. The media servers 450 may communicate via the local network 440 with media presentation devices 410 and/or 322. As previously described, the media presentation device 410 may be integrated into the vehicle 2100 (FIG. 21) or may be a portable device 322 (FIG. 3).

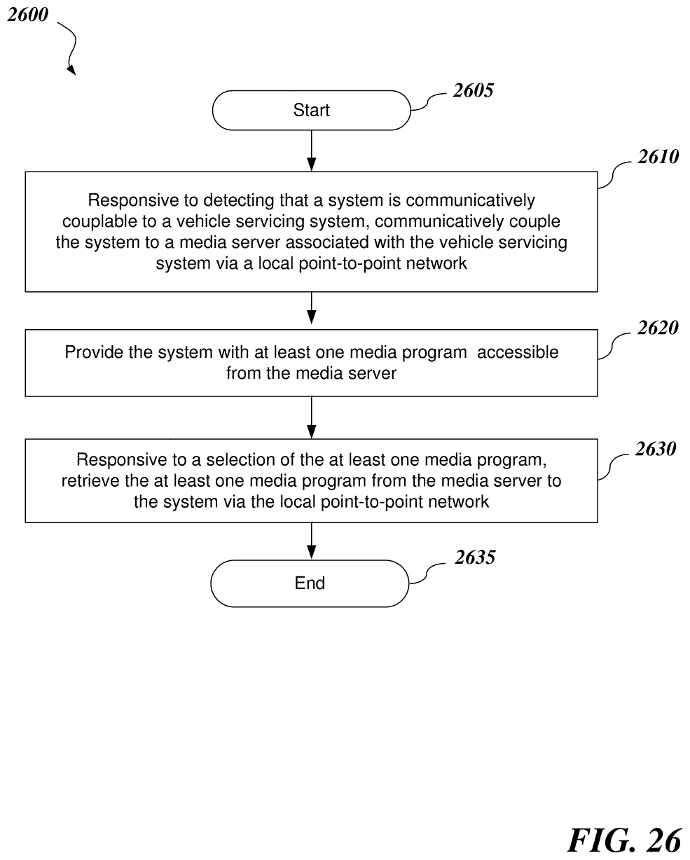

Referring to FIG. 26, an illustrative method 2600 is provided for providing media content from a media server associated with a vehicle servicing system to a media presentation device associated with a vehicle via a local network. The method 2600 starts at a block 2605. At a block 2610, responsive to detecting that a system, such as the media presentation device 410 (FIG. 4) is communicatively couplable to a vehicle servicing system, the system is communicatively coupled to a media server associated with the vehicle servicing system via a local network. At a block 2620, the system is provided with media content available from the media server and may be personalized for the user. At a block 2630, responsive to a selection of at least one media selection from the media content, the at least one media selection is retrieved from the media server to the system via the local network. The method 2600 ends at a block 2635.

Recommending Activities During Vehicle Servicing

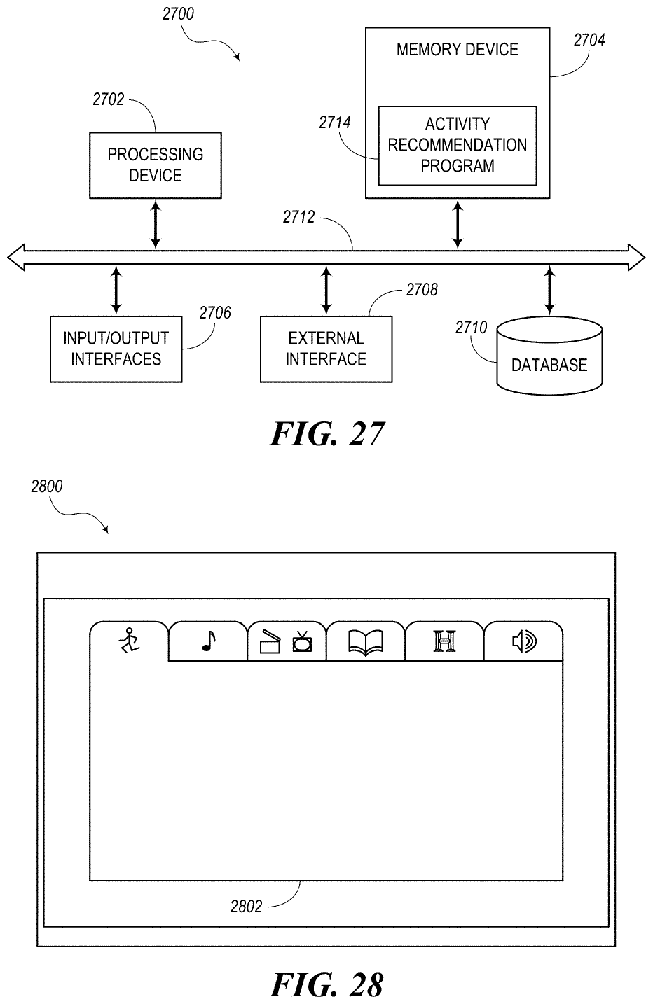

According to additional embodiments, the present disclosure describes systems and methods for providing “activity recommendations” to the occupants (e.g., driver and passengers) of a vehicle (e.g., vehicle 101, 201, 203, 2100, 2200, 2300, etc.). In particular, the following systems and methods are configured to communicate these activity recommendations to the occupants during the time that the vehicle is stationed at a vehicle servicing facility (e.g., vehicle servicing facility 100, 200, vehicle maintenance facility 160, charging station, or the like), particularly to receive some type of service (e.g., battery charging). These activities may be associated with various sites or settings that are nearby the vehicle servicing facility as detected by the computing system 2700 (FIG. 27). In one embodiment, the activity recommendations are based on user profile information stored by the computer system. For example, the computer system may detect that the user has previously visited art museums based on past destination input into the vehicle's navigation system and therefore may recommend a nearby art museum from the servicing facility. Additionally, the computer system may apply machine learning algorithms based on the user's profile (e.g., geographic location, previous destinations, age, music preferences, third-party service information, telematics data associated with the vehicle, etc.) to identify other user's having a similar profile and providing activity recommendations that match that particular user profile.

Referring to FIG. 27, a computing system 2700 is provided to enable communication of possible activities that the occupants may decide to take part in. As illustrated, the computing system 2700 includes a processing device 2702, a memory device 2704, Input/Output (I/O) interfaces 2706, an external interface 2708, and a database 2710. The components 2702, 2704, 2706, 2708, 2710 may be configured to communicate with each other via a local interface 2712 (e.g., bus interface, vehicle network, etc.). In some embodiments, the computing system 2700 may be the same as or may include many similarities to the computing device 2400 of FIG. 24. For example, the processing device 2702 may include similarities to the processing unit 2420. The memory device 2704 may include similarities to the system memory 2430, the removable storage 2440, and/or the non-removable storage 2450. The I/O interfaces 2706 may include similarities to the input device(s) 2460 and output device(s) 2470. The external interface 2708 may include similarities to the GPS/geolocation circuitry 2485 and communication system(s) 2480. Also, the database 2710 may include similarities to the program data 2434, removable storage 2440, and/or non-removable storage 2450.

In addition, the computing system 2700 may further include an activity recommendation program 2714. As illustrated, the activity recommendation program 2714 may be stored in the memory device 2704 or may be stored as an application 2432 in the system memory 2430. The activity recommendation program 2714 may be configured in any suitable combination of software or firmware in the memory device 2704 and/or may be configured in hardware in the processing device 2702. The activity recommendation program 2714 may include instructions, computer logic, etc., for enabling or causing the processing device 2702 (or multiple processing devices, ECUs, etc.) to perform certain functions related to providing recommendations to the occupants of the vehicle to entice them to “get out and stretch their legs.”

In some embodiments, diverse types of sensors (e.g., GPS/geolocation circuitry 2485, input devices 2460, I/O devices 2706, etc.) may be installed in the vehicle for detecting when the vehicle has been driven to a participating vehicle servicing facility. When the vehicle is positioned on the premises of the vehicle servicing facility or is connected to a charging station for electrically charging the battery, the sensors may detect that the vehicle has stopped for service at the vehicle servicing facility.

After detecting that the vehicle is at the vehicle servicing facility, the activity recommendation program 2714 (or other systems and methods of the present disclosure) may be configured to provide the activity recommendations to one or more people (i.e., occupants) present in the vehicle when the vehicle has been driven to the vehicle servicing facility. For example, these activities do not necessarily include typical in-vehicle entertainment, such as simply viewing a television show or watching a movie. Instead, the recommended activities are designed to get the occupants out of the vehicle and experience several types of adventures. This encouragement or inducement to get the occupants to take part in real-life activities can be a feature of the vehicle itself, a feature of the vehicle manufacturer, a feature of a consortium of manufacturers, a feature of health-based or nature-based organizations, etc. One goal may be to entice people out of their vehicles during vehicle maintenance or other service events, such as during a time when the battery of an electric vehicle is being charged, which may take about 30 minutes. Therefore, at least one of the activity recommendations includes an encouragement for the one or more people to take part in a “real-life experience.”

In some embodiments, the activity recommendation program 2714 is configured to receive information about the vehicle servicing facility where the vehicle is presently stationed, whereby this information may be stored in a central database or server configured to provide activity recommendations for multiple vehicle servicing facilities throughout a region, state, country, etc. The activity recommendations may be suggestions based on nearby attractions. The concept is to motivate or encourage people to discover unfamiliar areas, try new things, go on an adventure, etc.

According to various embodiments, the activity recommendation program 2714 may include a “game” component, which may be configured to turn the activity recommendation system into a game to provide an extrinsic motivation to the occupants who might otherwise be content to stay in the vehicle and watch a show. Thus, the recommendations may be associated with some type of incentive program. For example, in one example, the incentive program may include the game setup whereby the occupants are given digital tokens or credits for engaging in certain activities. Preferably, the activities receiving credits may be related to health and fitness, education/history, spiritual/emotional enlightenment, etc.

For example, each vehicle servicing facility (e.g., within a country or other region) might be located near one or more attractions. These attractions can be entered into a server or computer system, such that the systems and methods of the present disclosure can provide the occupants with information about the attractions, such as the distance to the attractions. The activities may include walking to these attractions, experiencing an adventure (e.g., hiking a trail, viewing a historic site, watching a sunset, bird watching, searching for items in a geo-caching game, going to a nearby ice cream parlor, etc.). In the game environment, a point system may be used to give higher points for more challenging or more difficult activities, may give higher points to encourage people to try new things they have not tried before, and/or may give higher points for attractions farther from a family's home.

In the game environment, the activity recommendation program 2714 may provide rewards only to the people who actually participate in the activity. Thus, in some embodiments, each individual may receive credit independently to thereby induce competition between family members and/or friends of a single vehicle. In some cases, however, a family (or the common occupants in a vehicle) may choose to receive credits as a whole. The systems and methods of the present disclosure may also be configured to record not only the credits received by the occupants in the one vehicle, but also the activity recommendation program 2714 may upload information to a cloud server to record the credits received by other occupants in other vehicles to thereby induce competition between different families. Rankings of individuals and/or families (by county, state, country, etc.) can also be recorded in a central computing system and displayed on the I/O devices 2706 (e.g., media presentation device) of each vehicle participating in the game.

The encouragement to engage in various activities may be based at least on the locations of various attractions and their vicinity to the respective vehicle servicing facilities. Also, certain activities may be recommended based on an estimated time the vehicle is intended to be serviced (e.g., estimated charging session duration) at the vehicle servicing facility. In some embodiments, mobile phones may be linked with the media presentation device to allow the people to be directed safety to nearby attractions, based on pre-stored information. Also, the battery charging stations may also include mobile phone charging.

The recommended activities may be grouped into various categories, such as, for example, a) health and fitness, b) educational/spiritual, c) entertainment/shopping, d) productivity, and e) others. For example, health/fitness may include nearby hiking/walking trails or scenic views (e.g., vistas, overlooks, etc.), nearby parks (e.g., local, state, federal parks) and activities that may be experienced there. Health/fitness may also include bird/animal watching, nearby disk golf courses (e.g., Frisbee golf courses), nearby geo-caching sites, scavenger hunts, nearby bicycle and/or electric scooter (e.g., Lime) rental (or complimentary usage thereof), and others.

The educational/spiritual category may include information about the locations of and/or walking instructions to and/or informational videos/text about nearby historic markers, nearby historic sites or museums. Other educational information may include the location of nearby historic buildings, statues, monuments, descriptions of nearby parks and attractions, etc. Also, other educational information may include learning about vehicle-related information (e.g., how to change a tire, how to maximize battery life, how to replace bulbs, etc.). This category may also include audio books, spiritually-based contend (e.g., audio of Bible reading, meditation suggestions, prayer tips, philosophical teachings, etc.).

The entertainment/shopping category may include the location of nearby ice cream parlors, nearby theaters, nearby shopping malls, nearby coffee shops, nearby grocery stores, nearby farmer stands, local attractions, etc. With respect to the game environment, some of these entertainment/shopping items may not be worth as many points as other activities. The system may be set up instead to provide greater reward to health and fitness and/or educational/spiritual activities to incentivize people to get involved with what may be considered to be more profitable (e.g., for physical or mental health and well-being). In some cases, known entertainment may be provided (e.g., television shows, movies, etc.), although these might not allow the people to receive points or credits in the game.

According to some embodiments, the activity recommendations or suggestions may be based on the age of each of the members of the vehicle. For example, this information can be entered when the people first utilize the system. Also, the recommendations may be based on pre-entered interests by these people. In some cases, the suggestions may be based on weather conditions, the time of day, the season of the year, etc. For example, if there is a storm outside, it may be inadvisable to recommend activities too far from the vehicle or vehicle servicing facility. Thus, as appropriated, the activity recommendation program 2714 may be configured to suggest inside-the-vehicle activities and outside-the-vehicle activities.

The activity recommendation program 2714 may further be configured to display an initial screen on an output device 2706 (e.g., media presentation device). The initial screen may be displayed the first time that the vehicle is brought to a participating vehicle servicing facility. The initial screen can be configured to give instructions to the occupants to explain how the activity recommendation systems and methods are designed to encourage adventure. The initial screen may also explain the “game” aspects (if the family so chooses to participate), the rules, the scoring, and the different types of activities that may be available at the present or other vehicle servicing facilities. In addition, the activity recommendation program 2714, using the initial screen, may be configured to get information about all members of a family or group, where the information for each member may include a name, age, birthday, gender, and other personal data. Also, the information may include interests of each member (e.g., hiking, geo-caching, etc.), abilities (e.g., athletic, and capable of most adventures), handicaps (e.g., allergies, wheelchair bound, etc.). Also, the initial screen may also be configured to allow each member to enter an avatar, photo, etc. for representing the person.

Subsequently, after receiving information from each of the members of vehicle, the activity recommendation program 2714 may be configured to display a regular activity recommendation screen with the understanding that the members know the rules of the game, etc. Nevertheless, the rules may be accessed from the screen if needed. Also, this screen may allow users to be added (e.g., extended family members, new family members, friends, etc.), may allow users to be deleted, may reset the game and point totals for a new family (e.g., if the vehicle is sold), etc. Also, the regular screen can show the points (e.g., tokens, credits, badges, etc.) received. The points may be displayed for any timeframe (e.g., weekly, monthly, yearly, lifetime, etc.) and may include rankings of family members, ranking of family versus other families, etc. In addition, the activity recommendation program 2714 may be configured to receive input about who is in the vehicle at the time when the vehicle is being serviced and who is actually doing what activities.

Referring to FIG. 28, a display screen 2800 may be provided on a display device (e.g., output device 2470, I/O device 2706, media presentation device, etc.) for showing folders 2802 of various categories of activities. For example, the folders 2802 may be associated with a “passport” file for storing the activities accomplished by the occupants. The passport file may be stored in any suitable memory. In some embodiments, the activity recommendation program 2714 may be configured to create the folders 2802 shown in FIG. 28 and/or may allow the occupants to enter new folders for new categories of activities. A non-limiting list of folders 2802 of the passport file for representing distinct types of activities may include, for example, one or more of health, music, movies, TV shows, podcasts, education, history, etc.

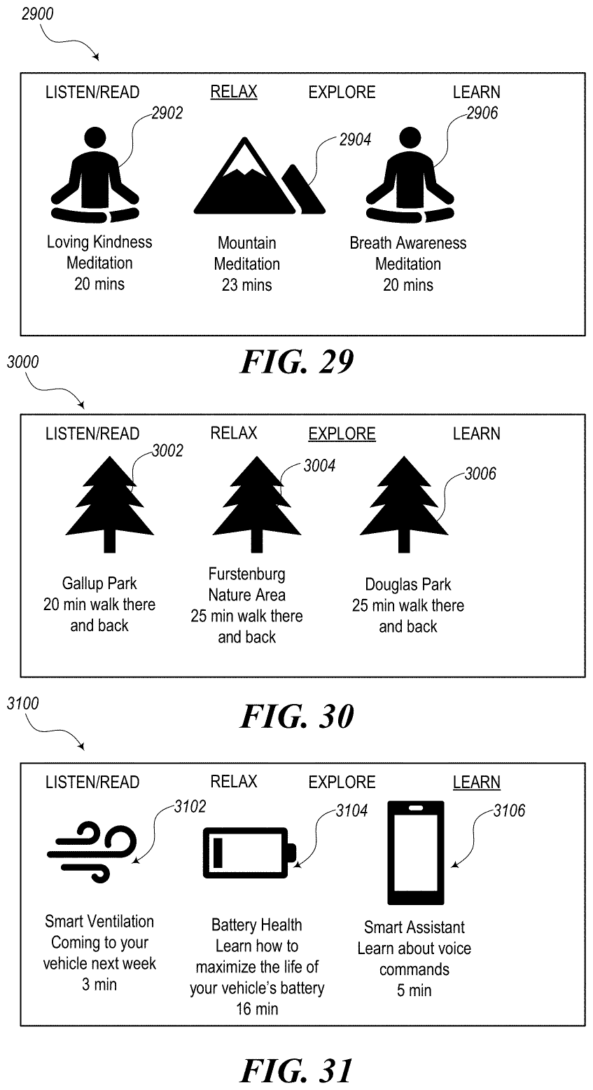

Referring to FIGS. 29-31, screens 2900, 3000, 3100 may be provided in the activity recommendation systems of the present disclosure (e.g., controlled by the activity recommendation program 2714). FIG. 29 shows a “relax” screen 2900, which may be associated with a spiritual or mental category of activities. The relax screen 2900 may be configured to show tokens 2902, 2904, 2906, in this example, to acknowledge one or more activities that the occupants have participated in regarding improving one's mental or spiritual well-being. FIG. 30 shows an “explore” screen 3000, which may be associated with a “health and fitness” or “adventure” category of activities. The explore screen 3000 may be configured to show tokens 3002, 3004, 3006, in this example, to acknowledge one or more activities that the occupants have participated in regarding improving one's physical well-being. FIG. 31 shows a “learn” screen 3100, which may be associated with an educational category of activities. The learn screen 3100 may be configured to show tokens 3102, 3104, 3106, in this example, to acknowledge one or more activities that the occupants have participated in regarding improving one's mind or intellect.

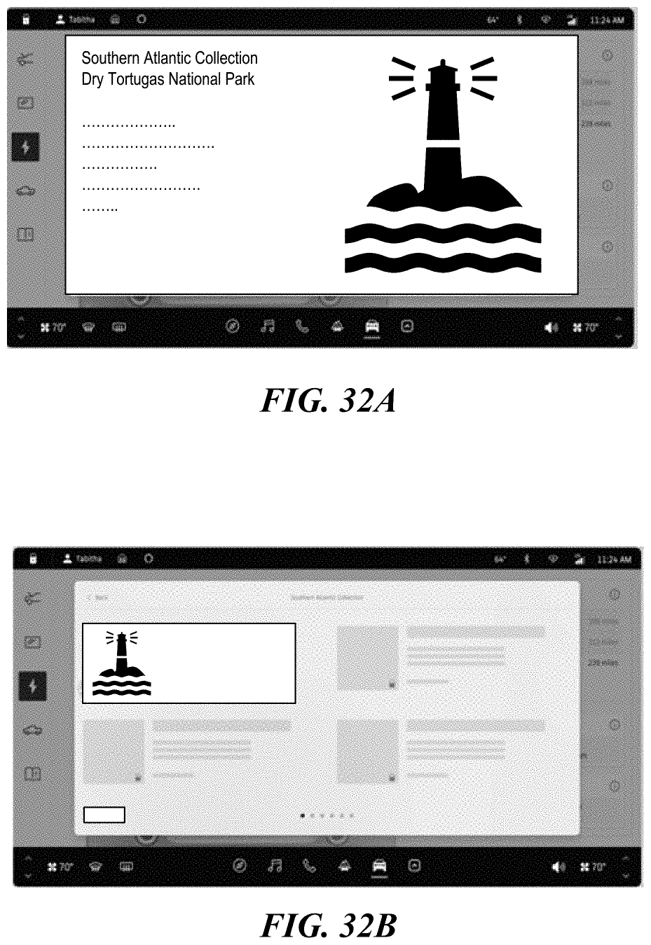

Referring to FIGS. 32A and 32B, it may be noted that the activity recommendation program 2714 (or other similar systems and methods of the present disclosure) may be configured in partnership with local park organizations, forestry/park services, nature organizations, camping/hiking organizations, family-friendly activity/game organizations, etc. As an example, FIG. 32A shows a screen where a description of a particular park (e.g., Dry Tortugas National Park), which may be within walking distance of one or more specific vehicle servicing facilities or alternatively may be a short drive from one or more vehicle servicing facilities. FIG. 32B shows an additional screen providing more information about Dry Tortugas National Park. Thus, in addition to media content providers, the present systems and methods may coordinate with the National Geographic Society, the History Channel, and/or others to motivate the occupants to learn, exercise, or otherwise engage in some activities for the benefit of the occupants. Some benefits, for example, may include the value of healthful practices, mental rewards, etc.

In some embodiments, the activity recommendation program 2714 may utilize input devices 2460, 2706 for allowing a user to upload digital images (photos) and/or comments, which can be stored in memory 2430, 2704, in a database 2710, etc. The activity recommendation program 2714, in some cases, may be configured to upload the photos and/or comments to the cloud for the benefit of other users of the activity recommendation systems. This may encourage other families to also get out and explore their surroundings, particularly in the areas near the vehicle servicing facilities throughout the region or country. Also, the photos and comments may help as possible suggestions for other to take part in certain activities in order to encourage real-life adventures.

Again, the activity recommendation program 2714 shown in FIG. 27 may include a game component, whereby points or credits are given for actively participating in certain activities. For example, the activity recommendation program 2714 may be configured to display a digital token (e.g., badge, medal, stamp, coin, ribbon, etc.) to show a most recent activity that was completed and a “passport” or a number screens (e.g., screens 2900, 3000, 3100) showing all the achievements during any time period in the past (e.g., weekly, monthly, yearly, lifetime, etc.).

In some embodiments, the game component of the activity recommendation program 2714 may be configured to ask the occupants for some type of verification that the activity has actually been done. For example, the participants may be required to scan a code on their mobile devices (e.g., cell phones), where the code may be placed on a specific object, building, plaque, monument, etc. to prove that the participants visited a specific site. In some cases, verification may include allowing the participants to take a picture on their cell phone (e.g., picture of a site, vista, monument, etc.) and upload the picture to the activity recommendation program 2714 via suitable input devices. In some cases, a code may be attached to or printed on a sign, marker, building, etc. using various letters, numbers, characters, colors, etc., whereby verification may include the participant entering the code into an input device for the activity recommendation game component. In still other ways to verify that the occupants of the vehicle have actually completed some activity, the activity recommendation program 2714 may ask the occupants one or more questions about a monument, vista, site, etc. to allow the occupants to answer the questions to prove that they were actually there.

The game component of the activity recommendation program 2714 may further be configured to record the tokens and activities completed in a suitable memory device. The game component may give points to each of the activities. The points may be different for different activities. Also, the point values may be variable, based on an administrator's control, depending on numerous factors. For example, more points may be awarded to activities that are at more remote vehicle servicing facilities (or outposts). Also, more points may be awarded to activities that are more challenging or those that provide a greater health or educational benefit to the participant.

Regarding the game component, the activity recommendation program 2714 may further be configured to keep track of the scores (e.g., points, credits, tokens, etc.) for each member of a family (based on who did what). If the family so chooses, these totals can be uploaded to a server (on the cloud) to participate in a family versus family competition. In this way, the family (or other group of occupants) may be able compare their scores with other families to invoke some friendly competition and to encourage families to “keep up with the Joneses” in an inter-family competition (e.g., city-wide, state-wide, and/or nation-wide). Also, in a version of a single vehicle game, an intra-family competition may be maintained with points for each occupant, depending on which member actually participated in certain activities.

The activity recommendation program 2714 may present points in the game on a suitable display device or screen. The possible points that can be obtained for each activity can be presented up front when the vehicle is first detected as being at the vehicle servicing facility and when the game screens are first opened up. In the game screens, the activity recommendation program 2714 may show the possible points to help people decide what they may want to do. Also, the points may be variable, based on the inverse of the popularity of the vehicle servicing facility, where more points may be awarded for more remote or less visited sites or when a real-time analysis determines certain facilities that are currently less busy. Thus, the points may be updated in real-time or based on trends throughout a region to encourage people to travel more, explore new sites, etc.

Also, extra points may be awarded in some scenarios when the participants are able to obtain a token for each of the major categories (e.g., health and fitness, educational, spiritual, etc.). For example, these major categories may represent the types of activities that one may find to be more beneficial for a healthy body and mind, as opposed to certain entertainment activities such as watching a TV show or movie or playing a video game. Again, the activity recommendation system is intended to encourage the people to get out of the vehicle (in many cases) and do some constructive or beneficial thing. The bonus or extra points for completing multiple categories may be provided to promote well-roundedness and to encourage a user to experience new or unique activities. The points may be based on difficulty level and may also depend on the experience level and/or abilities/handicaps to encourage all people. Also, points may be higher for activities that are farther from home, those that are more remote from popular sites, and/or are located at places where the occupants have never been before to again encourage adventurousness.

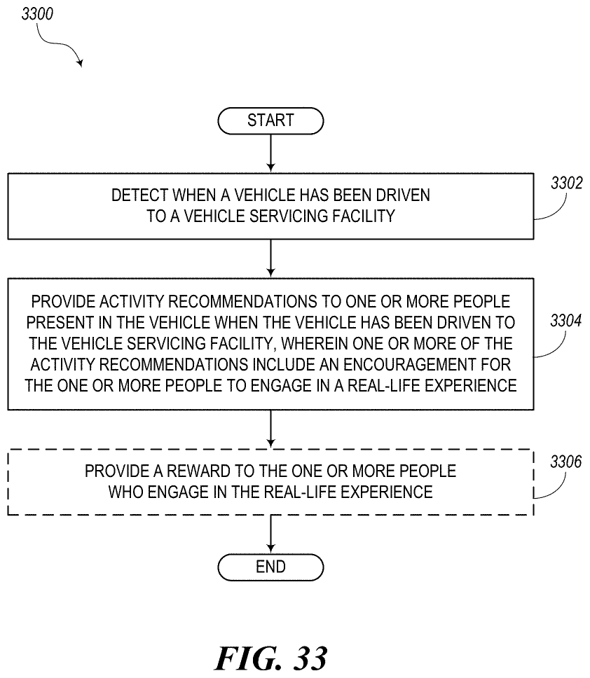

Referring to FIG. 33, a process 3300 is provided, which may be part of the functionality of the activity recommendation program 2714 and/or other systems and methods for encouraging occupants to participate in or engage in various activities near a vehicle servicing facility. As illustrated, the process 3300 include the step of detecting when a vehicle has been driven to a vehicle servicing facility, as indicated in block 3302. The process 3300 also include the step of providing activity recommendations to one or more people present in the vehicle when the vehicle has been driven to the vehicle servicing facility, as indicated in block 3304. For instance, one or more of the activity recommendations include an encouragement for the one or more people to engage in a real-life experience. In some embodiments, the process 3300 may be incorporated into a vehicle-based system or on-board system, such as one that includes an in-dash media interface for displaying information to the occupants and/or receiving input from the occupants.

According to some embodiments, the process 3300 may further include the step of providing a reward to the one or more people who engage in the real-life experience, as indicated in block 3306. For example, the reward may be in the form of a digital token or badge. The process 3300 may include the step of storing one or more digital tokens or badges in a passport file of a suitable memory device. Each of the activities associated with the activity recommendations may be assigned a specific number of points that may be obtained upon completion of the real-life experience. The process 3300 may also include the step of keeping a running total of the number of points for use in a personal game involving only the one or more people of the single vehicle and/or in a family-competition game involving members of other vehicles. The step of providing the reward may include the step of receiving some type of verification that the one or more people have actually engaged in the real-life experience.

The process 3300 may utilize a media presentation device, where the activity recommendations may be presented to the one or more people via the media presentation device. In addition, the process 3300 may include displaying an initial interactive screen on the media presentation device the first time that the vehicle is driven to the vehicle servicing facility. For instance, this initial interactive screen may be configured to display instructions to the one or more people to explain the general concept of the activity recommendations. The initial interactive screen may also be configured to receive information about the one or more people who wish to participate in the game. The initial screen is configured to display rules of a game associated with the activity recommendations and how points are scored in the game. Also, the process 3300 may include receiving one or more digital images or pictures from a user's mobile device in communication with the media presentation device. Also, the media presentation device may be configured to receive personal or personalized comments or commentary about the activities, which can be kept private for the sole use of the family and/or can be shared with others. The photos and/or comments can be uploaded to a media server that is configured to maintain the game for multiple participants in multiple vehicles.

The one or more activity recommendations may be provided based on their proximity to the vehicle servicing facility. The one or more activity recommendations may also be based on an estimated time that the vehicle is to be serviced at the vehicle servicing facility. In some cases, the vehicle may be an electric vehicle, whereby the vehicle servicing facility may include a charging station for charging the battery of the electric vehicle. As such, the estimated time may be based on a charging time for charging the electric vehicle.

Furthermore, the one or more activity recommendations described with respect to the process 3300 may be based on the age, interest level, and ability level of each of the one or more people. The one or more activity recommendations may also be based on current weather conditions at the vehicle servicing facility, the time of day, and the season of the year. The activity recommendations may include one or more inside recommendations and one or more outside recommendations. For example, the one or more inside recommendations may be configured to encourage the one or more people to engage in one or more activities inside the vehicle and the one or more outside recommendations may be configured to encourage the one or more people to engage in one or more activities outside the vehicle.

Also, the activity recommendations may be grouped into one or more categories including at least a health and fitness category, an educational category, a spiritual or mental health category, and an entertainment category, just to name a few. For example, the health and fitness category may include an encouragement for the one or more people to engage in one or more real-life experiences including a) visiting a nearby park, b) walking along a nearby hiking trail, c) observing a nearby scenic view, d) playing a game of disc golf, e) searching for geo-caching sites, f) observing nature, g) going on a scavenger hunt, h) renting a bike or electric scooter from a nearby rental facility, and/or other physically healthful activities. The educational category may include an encouragement for the one or more people to engage in one or more real-life experiences including a) viewing a video of a nearby park or historic site, b) viewing a video about vehicle maintenance, c) listening to an audio book, and/or other mental healthful activities. The spiritual or mental health category may include an encouragement for the one or more people to engage in one or more real-life experiences including a) listening to audio of Bible passages, b) listening to suggestions or instructions with respect to prayer or meditation, c) listening to philosophical quotes, and/or other spiritually healthful activities. The entertainment category may include an encouragement for the one or more people to engage in one or more real-life experiences including a) visiting a nearby ice cream parlor, theater, shopping mall, coffee shop, or farmer's stand, b) visiting a local attraction, and/or other entertaining activities that may include some level of physical or mental benefits.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

It will be appreciated that the detailed description set forth above is merely illustrative in nature and variations that do not depart from the gist and/or spirit of the claimed subject matter are intended to be within the scope of the claims. Such variations are not to be regarded as a departure from the spirit and scope of the claimed subject matter.

What is claimed is:

1. A vehicle-based system comprising:
a processing device, and
a memory device configured to store a computer program having instructions configured to enable the processing device to
detect a presence of a vehicle at a servicing facility,
based on the detected presence and a location of the servicing facility, determine one or more activity recommendations based on one or more activities that are nearby the servicing facility, and
provide display of the one or more activity recommendations to one or more people present in the vehicle.

2. The vehicle-based system of claim 1, wherein the instructions are further configured to enable the processing device to provide a reward to the one or more people who engage in the one or more activities associated with the one or more activity recommendations.

3. The vehicle-based system of claim 2, wherein the reward is in the form of a digital token or badge, and wherein the instructions are further configured to enable the processing device to store one or more digital tokens or badges in a passport file of the memory device.

4. The vehicle-based system of claim 3, wherein each of the activities associated with the activity recommendations is assigned a specific number of points that are obtained upon completion of the real-life experience, and wherein the instructions are further configured to enable the processing device to keep a running total of the number of points for use in a personal game involving only the one or more people or in a family-competition game involving members on other vehicles.

5. The vehicle-based system of claim 2, wherein providing the reward includes receiving verification that the one or more people have actually engaged in the one or more activities.

6. The vehicle-based system of claim 1, further comprising a media presentation device, wherein the activity recommendations are presented to the one or more people via the media presentation device.

7. The vehicle-based system of claim 6, wherein the instructions are further configured to enable the processing device to display an initial interactive screen on the media presentation device the first time that the vehicle is present at the vehicle servicing facility, wherein the initial interactive screen is configured to display instructions to the one or more people to explain a general concept of the activity recommendations, wherein the initial interactive screen is further configured to receive information about at least the one or more people.

8. The vehicle-based system of claim 7, wherein the initial screen is configured to display rules of a game associated with the activity recommendations and how points are scored in the game.

9. The vehicle-based system of claim 6, wherein the instructions are further configured to enable the processing device to
receive one or more digital images or personal comments from a mobile device in communication with the media presentation device, and
upload the one or more digital images or personal comments to a media server.

10. The vehicle-based system of claim 1, wherein the one or more activity recommendations are provided based on their proximity to the vehicle servicing facility.

11. The vehicle-based system of claim 1, wherein the one or more activity recommendations are based on one or more of
an estimated time that the vehicle is to be serviced at the vehicle servicing facility,
an estimated time for the vehicle to travel to a next waypoint or destination, and
an estimated time for a leg of a journey.

12. The vehicle-based system of claim 11, wherein the vehicle is an electric vehicle, wherein the vehicle servicing facility includes a charging station for charging the electric vehicle, and wherein the estimated time is based on a charging time for charging the electric vehicle.

13. The vehicle-based system of claim 1, wherein the one or more activity recommendations are based on the age, interest level, and ability level of each of the one or more people.

14. The vehicle-based system of claim 1, wherein the one or more activity recommendations are based on current weather conditions at the vehicle servicing facility, the time of day, and the season of the year.

15. The vehicle-based system of claim 1, wherein the activity recommendations include one or more inside recommendations and one or more outside recommendations, wherein the one or more inside recommendations are configured to encourage the one or more people to engage in one or more activities inside the vehicle, and wherein the one or more outside recommendations are configured to encourage the one or more people to engage in one or more activities outside the vehicle.

16. The vehicle-based system of claim 1, wherein the activity recommendations are grouped into one or more categories including at least a health and fitness category, an educational category, a spiritual or mental health category, and an entertainment category.

17. The vehicle-based system of claim 16, wherein:
the health and fitness category includes an encouragement for the one or more people to engage in one or more real-life experiences including one or more of visiting a nearby park, walking along a nearby hiking trail, observing a nearby scenic view, playing a game of disc golf, searching for geo-caching sites, observing nature, going on a scavenger hunt, and renting a bike or electric scooter from a nearby rental facility,
the educational category includes an encouragement for the one or more people to engage in one or more real-life experiences including one or more of viewing a video of a nearby park or historic site, viewing a video about vehicle maintenance, and listening to an audio book,
the spiritual or mental health category includes an encouragement for the one or more people to engage in one or more real-life experiences including one or more of listening to audio of passages, listening to suggestions or instructions with respect to prayer or meditation, and listening to philosophical quotes, and
the entertainment category includes an encouragement for the one or more people to engage in one or more real-life experiences including one or more of visiting a nearby ice cream parlor, theater, shopping mall, coffee shop, or farmer's stand, and visiting a local attraction.

18. A method comprising the steps of:
detecting a presence of a vehicle at a servicing facility,
based on the detected presence and a location of the servicing facility, determining one or more activity recommendations based on one or more activities that are nearby the servicing facility, and
providing display of the one or more activity recommendations to one or more people present in the vehicle.

19. The method of claim 18, further comprising the step of providing a reward to the one or more people who engage in the one or more activities associated with the one or more activity recommendations.

20. The method of claim 18, wherein the step of providing the display comprises displaying the one or more activity recommendations to the one or more people via a media presentation device.
